(19) United States
(12) Patent Application Publication
(10) Pub. No.: US 2026/0242625 A1
(43) Pub. Date: Aug. 20, 2026

(54) AQUEOUS INK, INK CARTRIDGE, INK JET RECORDING METHOD, AQUEOUS RESIN PARTICLE DISPERSION LIQUID AND METHOD OF PRODUCING AQUEOUS RESIN PARTICLE DISPERSION LIQUID

(71) Applicant: CANON KABUSHIKI KAISHA, Tokyo (JP)

(72) Inventors: AKEMI WATANABE, Kanagawa (JP); KATSUHIRO HAYASHI, Kanagawa (JP); KUNIAKI FUJIMOTO, Tokyo (JP)

(21) Appl. No.: 19/545,483

(22) Filed: Feb. 20, 2026

(30) Foreign Application Priority Data
Feb. 20, 2025 (JP) 2025-025597
Feb. 12, 2026 (JP) 2026-020931

(51) Int. Cl. C09D 11/30; B41J 2/175; C09D 11/107

(52) U.S. Cl. CPC C09D 11/30; C09D 11/107; B41J 2/17553

(57) ABSTRACT

Provided is an aqueous ink for ink jet that can record an image having satisfactory image clarity and has satisfactory storage stability. The aqueous ink for ink jet includes an aqueous medium and a resin particle. A resin for forming the resin particle is a copolymer having a unit derived from a monomer having an acid group. The resin particle contains 2 μmol/g or more to 60 μmol/g or less of an ammonium ion inside the resin particle. In addition, the surface acid group amount (μmol/g) of the resin particle is 100 μmol/g or more to 400 μmol/g or less.

### BACKGROUND

### Field of the Technology

The present disclosure relates to an aqueous ink, an ink cartridge, an ink jet recording method, an aqueous resin particle dispersion liquid and a method of producing an aqueous resin particle dispersion liquid.

### Description of the Related Art

A resin particle has been used as a binder for an aqueous ink or an aqueous paint. An aqueous resin particle dispersion liquid including a resin particle has been desired to satisfy the following: the physical properties of the aqueous resin particle dispersion liquid are not changed during a period from its production to the preparation of an ink or a paint through use of the aqueous resin particle dispersion liquid. In addition, the resin particle included in the ink or the paint has been required to have the following characteristic: the image clarity of a recorded image is satisfactory.

In, for example, Japanese Patent Laid-Open No. 2011-1557, there is a proposal of a method of producing a polymer emulsion (aqueous resin particle dispersion liquid) that improves the storage stability, clogging reliability and ejection stability of an ink composition. In addition, in Japanese Patent Laid-Open No. 2021-535239, there is a proposal of an aqueous ink for ink jet having a pH within a specific range in order to lengthen the life of a recording head of an ink jet system.

### SUMMARY

Accordingly, the present disclosure is directed to providing an aqueous ink for ink jet, which can record an image having satisfactory image clarity and has satisfactory storage stability, and an ink cartridge and an ink jet recording method each using the aqueous ink. The present disclosure is also directed to providing an aqueous resin particle dispersion liquid, which can prepare an aqueous ink for ink jet capable of recording an image having satisfactory image clarity and has satisfactory storage stability, and a method of producing an aqueous resin particle dispersion liquid.

That is, according to one aspect of the present disclosure, there is provided an aqueous ink for ink jet including: an aqueous medium; and a resin particle, wherein a resin for forming the resin particle is a copolymer having a unit derived from a monomer having an acid group, wherein the resin particle contains 2 μmol/g or more to 60 μmol/g or less of an ammonium ion inside the resin particle, and wherein a surface acid group amount (μmol/g) of the resin particle is 100 μmol/g or more to 400 μmol/g or less.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view for schematically illustrating an ink cartridge according to one embodiment of the present disclosure.

FIG. 2A and FIG. 2B are views for schematically illustrating an example of an ink jet recording apparatus to be used in an ink jet recording method of the present disclosure. FIG. 2A is a perspective view of the main portion of the ink jet recording apparatus and FIG. 2B is a perspective view of a head cartridge.

### DESCRIPTION OF THE EMBODIMENTS

The present disclosure is described in more detail below by way of exemplary embodiments. In the present disclosure, when a compound is a salt, the salt is present in a state of dissociating into ions in an ink, but the expression “contains the salt” is used for convenience. In addition, an aqueous ink for ink jet is sometimes simply described as “ink”. Physical property values are values at normal temperature (25° C.), normal pressure (1 atm=101,325 Pa), and normal humidity (relative humidity: 50%) unless otherwise specified. In addition, with regard to a resin, the term “unit” means a unit structure corresponding to one monomer unless otherwise specified. The descriptions “(meth)acrylic acid,” “(meth)acrylate” and “(meth)acryloyl” represent “acrylic acid and methacrylic acid,” “an acrylate and a methacrylate” and “an acryloyl and a methacryloyl,” respectively.

The inventors have investigated the method of producing an aqueous resin particle dispersion liquid proposed in Japanese Patent Laid-Open No. 2011-1557. As a result, the inventors have found that when the aqueous resin particle dispersion liquid to be obtained is used for an aqueous ink while its storage stability is maintained, the image clarity of an image cannot be set to a high level required in recent years. The term “image clarity” as used herein refers to a characteristic indicating the sharpness of an image of an object when the object is reflected on the surface of the image. When the image clarity is low, the image looks blurred, and when the image clarity is high, the image looks sharp. In addition, the term “storage stability” means the property by which changes in physical properties of an aqueous resin particle dispersion liquid or an aqueous ink are suppressed under a usage environment and a distribution environment.

Meanwhile, the inventors have found that the ink proposed in Japanese Patent Laid-Open No. 2021-535239 does not contain any aqueous resin particle dispersion liquid, and hence the image clarity of an image to be obtained by using the ink is insufficient.

The inventors have investigated an aqueous ink for ink jet that can record an image having satisfactory image clarity while maintaining its storage stability. In addition, the inventors have investigated an aqueous resin particle dispersion liquid with a view to improving the image clarity of an image recorded with an aqueous ink prepared by using the aqueous resin particle dispersion liquid while maintaining the storage stability of the aqueous resin particle dispersion liquid. To improve the storage stability of each of the aqueous ink and the aqueous resin particle dispersion liquid, it is important for a resin particle to maintain a stable dispersed state in an aqueous medium. In each of the aqueous ink and the aqueous resin particle dispersion liquid, dispersion stability based on charge repulsion, which is caused by the dissociation of a surface acid group of the resin particle (group that may have an anionic property when dissociated), and constraint along with an interaction between molecules inside the resin particle is useful. A state in which an acid group is dissociated to have an anionic property is described as an anionic group below. Meanwhile, to obtain an image having satisfactory image clarity, the following is useful: when the ink is formed into a film on a recording medium, molecules in the filmed resin particle move to form a flat film.

The inventors have made an investigation, and as a result, have found that a resin particle having satisfactory dispersion stability is obtained when a resin for forming the resin particle has a unit derived from a monomer having an acid group, and a specific amount of an ammonium ion is incorporated into the resin particle. Satisfactory dispersion stability of the resin particle may be obtained as follows: an anionic group derived from the acid group and a specific amount of the ammonium ion are present inside the resin particle, and form an ammonium salt to generate a cohesive force along with an ionic bond inside the resin particle. In addition, the inventors have found that dispersion stability based on charge repulsion is maintained in the surface layer of the resin particle by controlling the amount of the anionic group derived from the surface acid group of the resin particle.

Further, when an image is recorded with the ink, the recombination of an ionic bond easily occurs between molecules inside the resin particle because the ammonium salt inside the resin particle is formed by an ionic bond between the anionic group derived from the acid group and the ammonium ion. Accordingly, when the ink is formed into a film on a recording medium, molecular movement is likely to occur between the resin particles and inside the resin particles, and hence a flat film is easily formed. As a result, an image having satisfactory image clarity can be obtained.

Accordingly, a copolymer having the unit derived from the monomer having an acid group is used as the resin for forming the resin particle. 2 Micromoles per gram or more to 60 μmol/g or less of an ammonium ion is incorporated into the resin particle, and the surface acid group amount of the resin particle is set to 100 μmol/g or more to 400 μmol/g or less. The configuration enables the recording of an image having satisfactory image clarity while satisfactorily maintaining the storage stability of the aqueous ink for ink jet. In addition, an aqueous ink for ink jet that can record an image having satisfactory image clarity can be prepared by using an aqueous resin particle dispersion liquid while satisfactorily maintaining the storage stability of the aqueous resin particle dispersion liquid.

### <Aqueous Resin Particle Dispersion Liquid>

An aqueous resin particle dispersion liquid of the present disclosure includes an aqueous medium and a resin particle. A resin for forming the resin particle is a copolymer having a unit derived from a monomer having an acid group. In addition, the resin particle contains inside itself a specific amount of an ammonium ion. Components for forming the aqueous resin particle dispersion liquid of the present disclosure and the physical properties of the aqueous resin particle dispersion liquid are described in detail below.

### (Resin Particle)

In the aqueous resin particle dispersion liquid, the resin particle is present under a state dispersed in the aqueous medium, that is, in the form of a resin emulsion. The content of the resin particle (solid content) in the aqueous resin particle dispersion liquid is preferably 10% by mass or more to 50% by mass or less, more preferably 20% by mass or more to 50% by mass or less with respect to the total mass of the aqueous resin particle dispersion liquid. The above-mentioned “resin particle (solid content)” may include solid components, such as an emulsifier and a polymerization initiator used for the synthesis of the resin, in addition to the resin particle formed of the monomer for forming the resin.

The term “resin particle” as used herein means a resin that can be dispersed in the aqueous medium and be present in the aqueous medium under a state having a particle diameter. Whether or not a resin corresponds to the “resin particle” may be determined in accordance with a method described below. First, a liquid containing a resin to be determined is diluted with pure water so as to have a resin content of about 1.0% by mass to prepare a sample. Then, when the particle diameter of the resin in the sample is measured by the dynamic light scattering method, and the presence of a particle having a particle diameter is recognized, the resin is determined to be a “resin particle” (i.e., “water-dispersible resin”). Meanwhile, when the presence of a particle having a particle diameter is not recognized, it is determined that the resin is not a “resin particle” (i.e., is a “water-soluble resin”). Measurement conditions in this case may be set, for example, as described below.

### [Measurement Conditions]

Set Zero: 30 seconds
Number of measurements: 3 times
Measurement time: 120 seconds
Shape: spherical
Refractive index: 1.5
Density: 1.0.

A particle size analyzer (e.g., a product available under the product name “NANOTRAC WAVE II-Q” from MicrotracBEL) or the like may be used as a particle size distribution-measuring apparatus based on the dynamic light scattering method. Needless to say, the particle size distribution-measuring apparatus, the measurement conditions and the like to be used are not limited to the foregoing.

[Amount of Ammonium Ion inside Resin Particle]

The resin particle is formed from the copolymer (resin) having the unit derived from the monomer having an acid group, and contains 2 μmol/g or more to 60 μmol/g or less of an ammonium ion inside the resin particle. When the amount of the ammonium ion inside the resin particle is less than 2 μmol/g, the number of ionic bonds between the ammonium ion and the acid group (anionic group) is small inside the resin particle, and hence a cohesive force inside the resin particle weakens to reduce the storage stability of the aqueous resin particle dispersion liquid. Meanwhile, when the amount of the ammonium ion inside the resin particle exceeds 60 μmol/g, filming between the resin particles is unlikely to proceed at the time of the recording of an image with an ink containing the resin particle because the cohesive force inside the resin particle is strong. As a result, the surface smoothness of the image is poor, and hence the image clarity of the image reduces. The amount of the ammonium ion inside the resin particle is preferably 5 μmol/g or more to 50 μmol/g or less from the viewpoint that the storage stability of the aqueous resin particle dispersion liquid and the image clarity of the image are more excellent. Ammonium salts, such as ammonia water, ammonium chloride and ammonium sulfate, may each be used as the ammonium ion.

The amount (μmol/g) of the ammonium ion inside the resin particle may be measured by ammonium ion concentration measurement using an ion chromatograph or the like. The ammonium ion incorporated into the resin particle can be eluted into the aqueous medium by storing the aqueous resin particle dispersion liquid for one month or more at a temperature equal to or more than the glass transition temperature of the resin particle and less than 100° C. (preferably 96° C. or less). A difference between the amounts of the ammonium ions incorporated into the aqueous medium before and after the storage of the aqueous resin particle dispersion liquid may be determined as the amount (μmol/g) of the ammonium ion that has been incorporated into the resin particle. The amount of the ammonium ion inside the resin particle may be controlled by, for example, the timing at which an ammonium salt is added at the time of the synthesis of the resin particle, a pH adjustment method at the time of the synthesis of the resin particle and heat treatment. The amount of the ammonium ion inside the resin particle includes those that exist in the form of the ammonium ion inside the resin particle as well as those that form the ammonium salt.

### [Monomer Having Acid Group]

The resin for forming the resin particle is the copolymer having the unit derived from the monomer having an acid group. The unit derived from the monomer having an acid group may be formed by, for example, polymerizing the monomer having an acid group. Inside the resin particle, the acid group (anionic group) is required to improve the storage stability of the aqueous resin particle dispersion liquid and the image clarity of an image, which is recorded with an ink containing the resin particle, through its interaction with the above-mentioned ammonium ion.

Examples of the monomer having an acid group may include a monomer having a carboxylic acid group, a monomer having a sulfonic acid group and a monomer having a phosphoric acid group. Those monomers are each a polymerizable monomer having a polymerizable reactive group such as an ethylenically unsaturated bond in a molecule thereof in addition to an acid group. Specifically, a monomer having an acid group and a (meth)acryloyloxy group, a monomer having an acid group and an allyl group and a monomer having an acid group and a vinyl group are preferred.

Examples of the monomer having a carboxylic acid group may include acrylic acid, methacrylic acid, maleic acid, fumaric acid and itaconic acid. Examples of the monomer having a sulfonic acid group may include styrenesulfonic acid, 2-sulfoethyl (meth)acrylate and a polymerizable surfactant having a sulfonic acid group. Examples of the polymerizable surfactant having a sulfonic acid group may include a polyoxyethylene-1-(allyloxymethyl)alkyl ether sulfate ammonium salt and an alkyl allyl sulfosuccinate. Examples of the monomer having a phosphoric acid group may include (meth)acryloyloxyethyl acid phosphate, 2-((meth)acryloyloxy)ethyl phosphate and a phosphate-type polymerizable surfactant. The examples may also include anionic monomers, such as an anhydride and salt of a monomer having an acid group. Examples of the salt include alkali metal salts such as lithium, sodium and potassium salts, ammonium salts and organic ammonium salts. The monomers each having an acid group may be used alone or in combination thereof.

### [Kind and Ratio of Acid Group]

The above-mentioned monomer having an acid group preferably includes a monomer having a carboxylic acid group and a monomer having a sulfonic acid group. That is, the resin for forming the resin particle preferably includes both of a unit derived from the monomer having a carboxylic acid group and a unit derived from the monomer having a sulfonic acid group. A carboxylic acid group is likely to form an ionic bond with an ammonium ion inside the resin particle, and a sulfonic acid group is likely to exhibit electrostatic repulsion on the surface of the resin particle. Accordingly, when the resin for forming the resin particle has both of a carboxylic acid group and a sulfonic acid group, the storage stability of the aqueous resin particle dispersion liquid is more easily improved. To effectively exhibit the effect, the ratio of the molar amount of a carboxylic acid group to the molar amount of a sulfonic acid group (carboxylic acid group-to-sulfonic acid group molar ratio) is preferably 8 or more to 22 or less, more preferably 10 or more to 20 or less. When the carboxylic acid group-to-sulfonic acid group molar ratio is 10 or more, the amount of a carboxylic acid group inside the resin particle is relatively large, and hence a cohesive force inside the resin particle easily increases moderately. Accordingly, the storage stability of the aqueous resin particle dispersion liquid easily becomes more satisfactory. Meanwhile, when the carboxylic acid group-to-sulfonic acid group molar ratio is 20 or less, the amount of a carboxylic acid group is suppressed to a relatively moderate level. Accordingly, the cohesive force inside the resin particle is moderately suppressed, and hence the resin particle is likely to form a film when an image is recorded with an ink containing the resin particle. Accordingly, the surface smoothness of the image becomes satisfactory, and hence the image clarity of the image is more easily improved.

### [Other Monomer]

The resin for forming the resin particle may have a unit derived from a monomer except the monomer having an acid group (hereinafter sometimes referred to as “other monomer”) together with the unit derived from the monomer having an acid group. A monomer copolymerizable with the monomer having an acid group may be used as the other monomer. The other monomer is a polymerizable monomer having a polymerizable reactive group such as an ethylenically unsaturated bond in a molecule thereof. Examples of the polymerizable reactive group may include a (meth)acryloyloxy group, an allyl group and a vinyl group.

Examples of the other monomer may include: (meth)acrylates, such as methyl (meth)acrylate, ethyl (meth)acrylate, butyl (meth)acrylate, cyclohexyl (meth)acrylate and 2-ethylhexyl (meth)acrylate; aromatic vinyls, such as styrene, 4-methylstyrene and 1-vinylnaphthalene; acrylonitrile; and methacrylonitrile. Those monomers may be used alone or in combination thereof.

### [Surface Acid Group Amount of Resin Particle]

The surface acid group amount (μmol/g) of the resin particle is 100 μmol/g or more to 400 μmol/g or less. The “surface acid group amount (μmol/g) of the resin particle” is represented by the amount (μmol) of an acid group present on the particle surface of the resin particle per unit mass (g) of the resin particle. Accordingly, in a state in which all the surface acid groups of the resin particle are dissociated, the surface acid group amount of the resin particle may be expressed as the amount of an anionic group on the surface of the resin particle. When the surface acid group amount of the resin particle is less than 100 μmol/g, the affinity of the resin particle for the aqueous medium is low, and hence aggregation is liable to occur between the resin particles. Accordingly, the storage stability of the aqueous resin particle dispersion liquid may reduce. Meanwhile, when the surface acid group amount of the resin particle exceeds 400 μmol/g, the affinity of the resin particle for the aqueous medium is so high that a drying property after the recording of an image with an ink containing the resin particle reduces. Accordingly, the surface smoothness of the image is impaired, and hence the image clarity thereof reduces in some cases.

The surface acid group amount (μmol/g) of the resin particle is more preferably 250 μmol/g or more to 350 μmol/g or less from the viewpoint that the storage stability of the aqueous resin particle dispersion liquid and the image clarity of the image are more excellent. The surface acid group amount (μmol/g) of the resin particle may be adjusted by, for example, the amount of the monomer having an acid group in the resin particle, the diameter of the particle and a method of producing the resin particle. The surface acid group amount (μmol/g) of the resin particle may be measured by colloid titration utilizing a potential difference at a pH of 12 or more through use of a methyl glycol chitosan solution as a titration reagent. To set the pH to 12 or more, a monovalent inorganic hydroxide aqueous solution is added to the measurement sample of the aqueous resin particle dispersion liquid to set its pH to 12 or more, and it is recognized that the pHis 12 or more even after the colloid titration. Thus, measurement with satisfactory reproducibility can be performed.

### [Dissociation Rate of Surface Acid Groups of Resin Particle at pH of 9]

It is preferred that 80% or more of the surface acid groups of the resin particle be dissociated at a pH of 9 to have anionic properties, and it is more preferred that 84% or more to 92% or less thereof be dissociated at a pH of 9 to have anionic properties. The value is the ratio of the latter of the following amounts to the former thereof: the above-mentioned surface acid group amount (i.e., the amount of all acid groups present on the surface of the resin particle) measured by the colloid titration utilizing a potential difference at a pH of 12 or more; and the amount of dissociated acid groups at a pH of 9 measured by a similar method after the adjustment of the pH of the measurement sample to 9. The ratio may be described as the dissociation rate of the surface acid groups of resin particle at a pH of 9. The term “pH of 9” as used herein means that the pH of the measurement sample is adjusted to 8.5 or more to less than 9.5, and measurement without any pH change before and after the colloid titration can be performed by adding, to the measurement sample, a pH buffer solution that can adjust its pH within the range. When the above-mentioned dissociation rate is 80% or more, the acid groups of the resin particle are sufficiently dissociated, and hence charge repulsion becomes sufficient. Accordingly, the dispersion stability of the resin particle is more easily improved. Meanwhile, when the above-mentioned dissociation rate is 92% or less, electrostatic repulsion between the resin particles is moderately suppressed, and hence filming between the resin particles easily proceeds at the time of the recording of an image. Accordingly, the surface smoothness of the image becomes satisfactory, and hence the image clarity of the image is more easily improved. The dissociation rate of the surface acid groups of the resin particle at a pH of 9 may be adjusted by the method of producing the resin particle.

### [Particle Diameter of Resin Particle]

The cumulative 50% particle diameter (D₅₀) of the volume-based particle size distribution of the resin particles is preferably 40 nm or more to 230 nm or less, more preferably 50 nm or more to 200 nm or less. When the D₅₀ of the resin particles is 50 nm or more, a surface area per mass of the resin particles is relatively small, and hence a contact probability between the resin particles becomes lower. Accordingly, aggregation between the resin particles is suppressed, and hence the storage stability of the aqueous resin particle dispersion liquid is more easily improved. Meanwhile, when the D₅₀ of the resin particles is 200 nm or less, unevenness derived from the resin particles in an image is suppressed after the recording of the image with an ink containing the resin particles, and hence the image clarity of the image more easily becomes satisfactory. The D₅₀ of the resin particles may be adjusted by a method of producing an aqueous resin particle dispersion liquid to be described later. The D₅₀ of the resin particles may be measured by a dynamic light scattering method under conditions similar to those of a method of determining whether or not the resin particles are the above-mentioned “resin particles.”

### [Glass Transition Temperature (Tg) of Resin Particle]

The glass transition temperature (Tg) of the resin particle is preferably 45° C. or more to 85° C. or less, more preferably 50° C. or more to 80° C. or less. When the Tg of the resin particle is 50° C. or more, the softening of the resin under the storage environment of the aqueous resin particle dispersion liquid is suppressed, and hence coalescence between the resin particles is unlikely to occur. Accordingly, the storage stability of the aqueous resin particle dispersion liquid is more easily improved. Meanwhile, when the Tg of the resin particle is 80° C. or less, the resin particle is likely to form a film at the time of the recording of an image with an ink containing the resin particle, and hence the image clarity of the image more easily becomes satisfactory. The Tg of the resin particle may be adjusted by the kind, amount, and molecular weight of the monomer used for the synthesis of the resin particle. The Tg of the resin particle is measured by differential scanning calorimetry (DSC) through use of the dried powder of the resin particle.

### (Aqueous Medium)

The aqueous resin particle dispersion liquid includes the aqueous medium. An aqueous medium similar to an aqueous medium used for an ink to be described later is preferably used as the aqueous medium, and deionized water or ion-exchanged water is more preferably used.

### (Other Component)

The aqueous resin particle dispersion liquid may include any other component as required in addition to the resin particle and the aqueous medium. Examples of the other component may include a surfactant and a pH adjuster.

### (Method of Producing Resin Particle)

Any known method may be used as a method of producing the resin particle as long as the configuration of the present disclosure described above is satisfied. Specifically, the resin particle may be produced by any one of methods, such as an emulsion polymerization method, a pre-emulsion polymerization method and a seed polymerization method. The resin particle may be synthesized by, for example, mixing monomers that serve as units for forming the resin for forming the resin particle and subjecting the mixture to emulsion polymerization. Thus, the aqueous resin particle dispersion liquid can be obtained. The emulsion polymerization is preferably performed in an aqueous liquid medium.

A method of producing an aqueous resin particle dispersion liquid including the following first step, second step and third step is preferred as a method of producing an aqueous resin particle dispersion liquid. The aqueous resin particle dispersion liquid of the present disclosure can be easily obtained by performing the first step, the second step and the third step in the stated order:
First step: a step of subjecting a monomer component including a monomer having an acid group to emulsion polymerization in the presence of an ammonium salt to provide a first aqueous dispersion containing a resin particle;
Second step: a step of adjusting the pH of the first aqueous dispersion obtained in the first step to 6.5 or more to 9.5 or less to provide a second aqueous dispersion; and
Third step: a step of performing the heat treatment of the second aqueous dispersion at a temperature equal to or more than the glass transition temperature of the resin particle for 24 hours or less after the second step.

In the first step, the above-mentioned monomer having an acid group is used as the monomer component, and the above-mentioned other monomer may be further used in addition thereto. As described above, ammonia water, ammonium chloride, ammonium sulfate and the like may each be used as the ammonium salt. As described above, the emulsion polymerization is preferably performed in an aqueous liquid medium. In the emulsion polymerization, a polymerization initiator or a surfactant may be used.

When the pH of the first aqueous dispersion obtained in the first step is adjusted to less than 6.5 in the second step, the dissociation of an anionic group of the resin particle is liable to be insufficient, and hence it is difficult to improve the storage stability of the aqueous resin particle dispersion liquid. Meanwhile, when the above-mentioned pH exceeds 9.5, electrostatic repulsion between the resin particles becomes so high that filming between the resin particles is unlikely to proceed at the time of the recording of an image with an ink. Accordingly, the surface smoothness of the image is impaired, and hence the image clarity of the image is unlikely to be satisfactory. The adjustment of the pH is preferably performed by adding a monovalent inorganic hydroxide, and a compound having a pH buffering property may be used in combination therewith.

When the temperature of the heat treatment in the third step is less than the glass transition temperature (Tg) of the resin particle, the molecules of the resin cannot move, and hence the above-mentioned dissociation rate reduces. Accordingly, the dispersion stability of the aqueous resin particle dispersion liquid is liable to be impaired. In addition, when the time of the heat treatment at the Tg of the resin particle or more exceeds 24 hours, ammonium inside the resin particle is eluted, and hence the number of ionic bonds between ammonium and an acid group reduces inside the resin particle. Accordingly, a cohesive force inside the resin particle is liable to weaken to impair the storage stability of the aqueous resin particle dispersion liquid. The temperature of the heat treatment in the third step is preferably less than 100° C., more preferably 96° C. or less.

When the above-mentioned first step, second step and third step are performed in the stated order, an appropriate amount of an ammonium ion is held inside the resin particle, and hence the anionic groups are dissociated on the surface of the resin particle. Thus, the storage stability of the aqueous resin particle dispersion liquid and the image clarity of an image recorded with an aqueous ink prepared by using the aqueous resin particle dispersion liquid can be made satisfactory.

### <Aqueous Ink>

An aqueous ink for ink jet of the present disclosure includes an aqueous medium and a resin particle. The ink may be prepared by using the above-mentioned aqueous resin particle dispersion liquid. The use of the aqueous resin particle dispersion liquid can incorporate the above-mentioned resin particle into the ink. From the viewpoint that an image having excellent image clarity can be recorded, the ink preferably includes the above-mentioned aqueous resin particle dispersion liquid (the resin particle and the aqueous medium), a pigment and a water-soluble organic solvent, and more preferably further includes a surfactant in addition to these components.

### (Resin Particle)

The ink includes the above-mentioned resin particle. The resin particle is present in the ink under a dispersed state, that is, in the form of a particle. The content (% by mass) of the resin particle in the aqueous ink is preferably 2.0% by mass or more to 20.0% by mass or less, more preferably 5.0% by mass or more to 15.0% by mass or less with respect to the total mass of the ink. When the content of the resin particle in the ink is 5.0% by mass or more, a resin amount at the time of film formation by the ink is sufficient, and the image clarity of an image more easily becomes satisfactory. Meanwhile, when the content of the resin particle in the ink is 15.0% by mass or less, the viscosity of the ink is suppressed, and hence the dispersion stability of the resin particle in the ink easily becomes satisfactory.

In addition, the content (% by mass) of the resin particle in the aqueous ink is preferably 0.5 times or more to 7.0 times or less, more preferably 1.0 times or more to 5.0 times or less in terms of mass ratio to the content (% by mass) of the pigment. When the content of the resin particle is 1.0 times or more as large as the content of the pigment in the ink, the resin amount at the time of the film formation by the ink is sufficient, and hence the image clarity of the image more easily becomes satisfactory. In addition, when the content of the resin particle is 5.0 times or less as large as the content of the pigment in the ink, the viscosity of the ink is suppressed, and hence the dispersion stability of the resin particle in the ink easily becomes satisfactory.

The particle diameter (D₅₀) of the resin particles incorporated into the ink, the amount of ammonium ions inside the particles, the surface acid group amount thereof, the dissociation rate of the surface acid groups thereof at a pH of 9 and the glass transition temperature (Tg) thereof may each be measured by a method similar to that for the above-mentioned aqueous resin particle dispersion liquid through use of the resin particles removed from the ink.

### (Pigment)

The ink preferably includes a pigment as a coloring material. The content (% by mass) of the pigment in the ink is preferably 0.1% by mass or more to 15.0% by mass or less, more preferably 1.0% by mass or more to 10.0% by mass or less with respect to the total mass of the ink.

Specific examples of the pigment may include an inorganic pigment and an organic pigment. Examples of the inorganic pigment may include carbon black and titanium oxide. Examples of the organic pigment may include an azo pigment, a phthalocyanine pigment, a quinacridone pigment, an isoindolinone pigment, an imidazolone pigment, a diketopyrrolopyrrole pigment, a dioxazine pigment and a perinone pigment. The pigments may be used alone or in combination thereof.

A resin-dispersed pigment using a resin (resin dispersant) as a dispersant, a self-dispersible pigment, in which a hydrophilic group is bonded to the particle surface of a pigment, or the like may be used as a pigment dispersion system. In addition, a resin-bonded pigment in which an organic group containing a resin is chemically bonded to a pigment particle surface, a microcapsule pigment, in which a pigment particle surface is coated with a resin or the like, or the like may be used. Of those, a resin-dispersed pigment, which is dispersed with a resin dispersant physically adsorbed onto the particle surface of the pigment, or a self-dispersible pigment, in which an anionic group is bonded to the particle surface of the pigment directly or via another atomic group, is preferred.

A resin that can disperse the pigment in the aqueous medium through the action of an anionic group is preferably used as a resin dispersant for dispersing the pigment in the aqueous medium, and a water-soluble resin having an anionic group is more preferably used. Examples of the resin dispersant may include an acrylic resin and a urethane-based resin. Of those, an acrylic resin is preferred, and an acrylic resin having a hydrophilic unit and a hydrophobic unit as constituent units is more preferred. In particular, an acrylic resin having a hydrophilic unit derived from (meth)acrylic acid and a hydrophobic unit derived from a monomer having an aliphatic group or an aromatic group is preferred.

The hydrophilic unit is a unit having a hydrophilic group, such as an anionic group, a hydroxy group or an ethylene oxide group. The hydrophilic unit may be formed by, for example, polymerizing a monomer having a hydrophilic group. Specific examples of the monomer having a hydrophilic group may include: acidic monomers each having a carboxylic acid group such as (meth)acrylic acid; anionic monomers, such as anhydrides and salts of these acidic monomers; monomers each having a hydroxy group such as 2-hydroxyethyl (meth)acrylate; and monomers each having an ethylene oxide group such as methoxypolyethylene glycol (meth)acrylate. Examples of cations for forming the salts of the acidic monomers may include the ions of lithium, sodium, potassium, ammonium and an organic ammonium. The monomers each having a hydrophilic group may be used alone or in combination thereof.

The hydrophobic unit is a unit free of a hydrophilic group, such as an anionic group, a hydroxy group or an ethylene oxide group. The hydrophobic unit may be formed by, for example, polymerizing a hydrophobic monomer free of a hydrophilic group. Specific examples of the hydrophobic monomer may include: monomers each having an aromatic group, such as styrene, α-methylstyrene and benzyl (meth)acrylate; and monomers each having an aliphatic group, such as ethyl (meth)acrylate, methyl (meth)acrylate, (iso-) propyl (meth)acrylate, butyl (meth)acrylate and 2-ethylhexyl (meth)acrylate. The hydrophobic monomers may be used alone or in combination thereof.

The self-dispersed pigment may be, for example, a pigment in which an anionic group is bonded to a pigment particle surface directly or via any other atomic group. Examples of the anionic group may include a carboxylic acid group, a sulfonic acid group, a phosphoric acid group and a phosphonic acid group. Examples of the counter ion of the anionic group may include the cations of a hydrogen atom, an alkali metal, ammonium and an organic ammonium. The other atomic group is a group having a function as a spacer between the pigment particle surface and the anionic group, and preferably has a molecular weight of 1,000 or less. Examples of the other atomic group may include: an alkylene group having about 1 to 6 carbon atoms; arylene groups, such as a phenylene group and a naphthylene group; an ester group; an imino group; an amide group; a sulfonyl group; and an ether group. A group in which those groups are combined is also permitted.

### (Aqueous Medium)

The ink is an aqueous ink including at least water as an aqueous medium. The ink may include an aqueous medium that is water or a mixed solvent of water and a water-soluble organic solvent. Deionized water or ion-exchanged water is preferably used as the water. The content (% by mass) of the water in the ink is preferably 40.0% by mass or more to 95.0% by mass or less, more preferably 50.0% by mass or more to 90.0% by mass or less with respect to the total mass of the ink. The content (% by mass) of the water-soluble organic solvent in the ink is preferably 2.0% by mass or more to 45.0% by mass or less, more preferably 3.0% by mass or more to 40.0% by mass or less with respect to the total mass of the ink.

### (Water-Soluble Organic Solvent)

Examples of the water-soluble organic solvent may include polyhydric alcohols, polyhydric alcohol alkyl ethers, polyhydric alcohol aryl ethers, nitrogen-containing heterocyclic compounds, amides, amines, sulfur-containing compounds, propylene carbonate and ethylene carbonate. The water-soluble organic solvents may be used alone or in combination thereof.

Examples of the polyhydric alcohols may include ethylene glycol, 1,3-butanediol, 1,5-pentanediol, 3-methyl-1,3-butanediol, 1,6-hexanediol, diethylene glycol, triethylene glycol, tetraethylene glycol, polyethylene glycol, propylene glycol, dipropylene glycol, tripropylene glycol, polypropylene glycol, glycerin, 1,2,6-hexanetriol, 1,2,4-butanetriol, 1,2,3-butanetriol and petrichor.

Examples of the polyhydric alcohol alkyl ethers may include ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether and propylene glycol monoethyl ether. Examples of the polyhydric alcohol aryl ethers may include ethylene glycol monophenyl ether and ethylene glycol monobenzyl ether.

Examples of the nitrogen-containing heterocyclic compounds may include N-methyl-2-pyrrolidone, N-hydroxyethyl-2-pyrrolidone, 2-pyrrolidone, 1,3-dimethylimidazolidinone and 8-caprolactam. Examples of the amides may include formamide, N-methylformamide and N,N-dimethylformamide. Examples of the amines may include monoethanolamine, diethanolamine, triethanolamine, monoethylamine, diethylamine and triethylamine. Examples of the sulfur-containing compounds may include dimethyl sulfoxide, sulfolane, thiodiethanol and thiodiglycol.

One kind or two or more kinds belonging to any group of the above-mentioned various water-soluble organic solvents may be used. Of the water-soluble organic solvents listed above, one kind or two or more kinds of the following water-soluble organic solvents are preferred because excellent effects are obtained for solubility and the prevention of a defective jetting characteristic due to water evaporation. That is, glycerin, ethylene glycol, 1,3-butanediol, 1,5-pentanediol, 3-methyl-1,3-butanediol, 1,6-hexanediol, diethylene glycol, triethylene glycol, propylene glycol, dipropylene glycol, tripropylene glycol, polyethylene glycol, 1,2,4-butanetriol, 1,2,6-hexanetriol, thiodiglycol, 2-pyrrolidone, N-methyl-2-pyrrolidone and N-hydroxyethyl-2-pyrrolidone are preferred. Of those, glycerin, diethylene glycol, 1,3-butanediol, 1,5-pentanediol, 3-methyl-1,3-butanediol, 1,6-hexanediol, 2-pyrrolidone and N-methyl-2-pyrrolidone are more preferred.

### (Surfactant)

The ink may include the surfactant. Examples of the surfactant may include an anionic surfactant, a cationic surfactant, a nonionic surfactant, a fluorine-based surfactant and an amphoteric surfactant. Those surfactants may be used alone or in combination thereof. Of those, an anionic surfactant and a nonionic surfactant are preferred.

Examples of the anionic surfactant may include: an alkylallyl sulfonate; an alkylnaphthalene sulfonate; an alkyl phosphate; an alkyl sulfate; an alkyl sulfonate; an alkyl ether sulfate; an alkyl sulfosuccinate; an alkyl ester sulfate; an alkylbenzene sulfonate; an alkyldiphenyl ether disulfonate; an alkylaryl ether phosphate; an alkylaryl ether sulfate; an alkylaryl ether ester sulfate; an olefin sulfonate; an alkane olefin sulfonate; a polyoxyethylene alkyl ether phosphate; a polyoxyethylene alkyl ether sulfate; an ether carboxylate; a sulfosuccinate; an α-sulfo fatty acid ester; a fatty acid salt; a condensate of a higher fatty acid and an amino acid; and a naphthenate. Of those, a polyoxyethylene alkyl ether acetate and a dialkyl sulfosuccinate are preferred.

Examples of the nonionic surfactant may include an acetylene glycol-based surfactant, a polyoxyethylene alkyl ether, a polyoxyethylene alkylphenyl ether, a polyoxyethylene alkyl ester and a polyoxyethylene sorbitan fatty acid ester.

### (Other Component)

The ink may include any other component as required in addition to the above-mentioned components. Examples of the other component may include a pH adjuster, a preservative/mildewproofing agent, a rust inhibitor, an antioxidant, a UV absorber, an oxygen absorber and a light stabilizer.

The pH adjuster is not particularly limited as long as the adjuster can adjust the pH of the ink to 7 or more, and any substance may be used in accordance with purposes. Examples of the pH adjuster may include: amines, such as diethanolamine and triethanolamine; alkali metal hydroxides, such as lithium hydroxide, sodium hydroxide and potassium hydroxide; ammonium hydroxide, a quaternary ammonium hydroxide and a quaternary phosphonium hydroxide; and alkali metal carbonates, such as lithium carbonate, sodium carbonate and potassium carbonate.

Examples of the preservative/mildewproofing agent may include 1,2-benzisothiazolin-3-one, sodium dehydroacetate, sodium sorbate, sodium 2-pyridinethiol-1-oxide, sodium benzoate and sodium pentachlorophenol.

Examples of the rust inhibitor may include an acid sulfite, sodium thiosulfate, ammonium thiodiglycolate, diisopropylammonium nitrite, pentaerythritol tetranitrate and dicyclohexylammonium nitrite.

Examples of the antioxidant may include a phenol-based antioxidant (including a hindered phenol-based antioxidant), an amine-based antioxidant, a sulfur-based antioxidant and a phosphorus-based antioxidant. Examples of the phenol-based antioxidant (including a hindered phenol-based antioxidant) may include butylated hydroxyanisole, 2,6-di-tert-butyl-4-ethylphenol, stearyl-β-(3,5-di-tert-butyl-4-hydroxyphenyl) propionate, 2,2′-methylenebis(4-methyl-6-tert-butylphenol), 2,2′-methylenebis(4-ethyl-6-tert-butylphenol), 4,4′-butylidenebis(3-methyl-6-tert-butylphenol), 3,9-bis[1,1-dimethyl-2-[β-(3-tert-butyl-4-hydroxy-5-methylphenyl) propionyloxy]ethyl]2,4,8,10-tetraoxaspiro[5,5]undecane, 1,1,3-tris(2-methyl-4-hydroxy-5-tert-butylphenyl) butane, 1,3,5-trimethyl-2,4,6-tris(3,5-di-tert-butyl-4-hydroxybenzyl)benzene and tetrakis[methylene-3-(3′,5′-di-tert-butyl-4′-hydroxyphenyl) propionate]methane. Examples of the amine-based antioxidant may include phenyl-β-naphthylamine, α-naphthylamine, N,N′-di-sec-butyl-p-phenylenediamine, phenothiazine, N,N′-diphenyl-p-phenylenediamine, 2,6-di-tert-butyl-p-cresol, 2,6-di-tert-butylphenol, 2,4-dimethyl-6-tert-butyl-phenol, butylhydroxyanisole, 2,2′-methylenebis(4-methyl-6-tert-butylphenol), 4,4′-butylidenebis(3-methyl-6-tert-butylphenol), 4,4′-thiobis(3-methyl-6-tert-butylphenol), tetrakis[methylene-3 (3,5-di-tert-butyl-4-hydroxyphenyl) propionate]methane and 1,1,3-tris(2-methyl-4-hydroxy-5-tert-butylphenyl) butane. Examples of the sulfur-based antioxidant may include dilauryl 3,3′-thiodipropionate, distearyl thiodipropionate, lauryl stearyl thiodipropionate, dimyristyl 3,3′-thiodipropionate, distearyl β,β′-thiodipropionate, 2-mercaptobenzimidazole and dilauryl sulfide. Examples of the phosphorus-based antioxidant may include triphenyl phosphite, octadecyl phosphite, triisodecyl phosphite, trilauryl trithiophosphite and trinonylphenyl phosphite.

Examples of the UV absorber may include a benzophenone-based UV absorber, a benzotriazole-based UV absorber, a salicylate-based UV absorber, a cyanoacrylate-based UV absorber and a nickel complex-based UV absorber. Examples of the benzophenone-based UV absorber may include 2-hydroxy-4-n-octoxybenzophenone, 2-hydroxy-4-n-dodecyloxybenzophenone, 2,4-dihydroxybenzophenone, 2-hydroxy-4-methoxybenzophenone and 2,2′,4,4′-tetrahydroxybenzophenone. Examples of the benzotriazole-based UV absorber may include 2-(2′-hydroxy-5′-tert-octylphenyl)benzotriazole, 2-(2′-hydroxy-5′-methylphenyl)benzotriazole, 2-(2′-hydroxy-4′-octoxyphenyl)benzotriazole and 2-(2′-hydroxy-3′-tert-butyl-5′-methylphenyl)-5-chlorobenzotriazole. Examples of the salicylate-based UV absorber may include phenyl salicylate, p-tert-butylphenyl salicylate and p-octylphenyl salicylate. Examples of the cyanoacrylate-based UV absorber may include ethyl-2-cyano-3,3′-diphenylacrylate, methyl-2-cyano-3-methyl-3-(p-methoxyphenyl) acrylate and butyl-2-cyano-3-methyl-3-(p-methoxyphenyl) acrylate. Examples of the nickel complex-based UV absorber may include nickel bis(octylphenyl) sulfide, 2,2′-thiobis(4-tert-octylphenolato)-n-butylamine nickel (II), 2,2′-thiobis(4-tert-octylphenolato)-2-ethylhexylamine nickel (II) and 2,2′-thiobis(4-tert-octylphenolato)triethanolamine nickel (II).

### (Physical Properties of Ink)

The ink of the present disclosure is an aqueous ink to be applied to an ink jet system. Accordingly, it is preferred that the physical property values thereof be appropriately controlled from the viewpoint of reliability. The viscosity of the ink at 25° C. is preferably 1.0 mPa·s or more to 10.0 mPa·s or less, more preferably 2.0 mPa·s or more to 7.0 mPa·s or less. In addition, the surface tension of the ink at 25° C. is preferably 10 mN/m or more to 60 mN/m or less, more preferably 20 mN/m or more to 60 mN/m or less, still more preferably 30 mN/m or more to 50 mN/m or less. The pH of the ink at 25° C. is preferably 6.0 or more to 10.0 or less, more preferably 6.5 or more to 10.0 or less, still more preferably 7.0 or more to 9.5 or less. When the pH of the ink is 7.0 or more, the dissociation rates of the resin particle and the pigment are likely to increase, and hence charge repulsion is easily exhibited. Accordingly, the dispersion stability of the resin particle is more easily improved. Meanwhile, when the pH of the ink is 9.5 or less, electrostatic repulsion between the resin particles is moderately suppressed at the time of film formation on a recording medium by the ink, and hence the unevenness of a film surface is suppressed. Accordingly, the image clarity of an image is more easily improved.

### <Ink Cartridge>

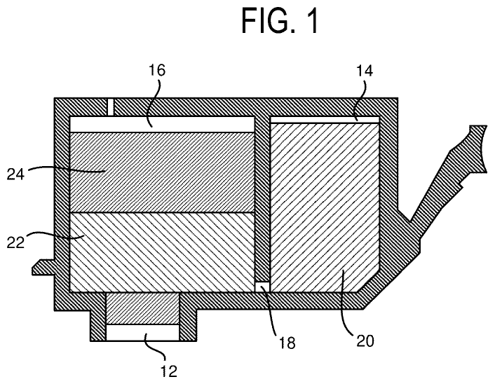

An ink cartridge of the present disclosure includes an ink and an ink storage portion configured to store the ink. In addition, the ink stored in the ink storage portion is the aqueous ink of the present disclosure described above. FIG. 1 is a sectional view for schematically illustrating an ink cartridge according to one embodiment of the present disclosure. As illustrated in FIG. 1, an ink supply port 12 for supplying an ink to a recording head is arranged on the bottom surface of the ink cartridge. The inside of the ink cartridge is the ink storage portion for storing the ink. The ink storage portion includes an ink storage chamber 14 and an absorbent storage chamber 16, and the chambers communicate to each other through a communication port 18. In addition, the absorbent storage chamber 16 communicates to the ink supply port 12. While a liquid ink 20 is stored in the ink storage chamber 14, absorbents 22 and 24 each of which holds the ink in a state of being impregnated therewith are stored in the absorbent storage chamber 16. The ink storage portion may be configured to be free of an ink storage chamber that stores the liquid ink and to hold the total amount of the ink to be stored with the absorbents. In addition, the ink storage portion may be configured to be free of an absorbent and to store the total amount of the ink in a liquid state.

Further, an ink cartridge configured to include the ink storage portion and a recording head may be adopted.

### <Ink Jet Recording Method>

An ink jet recording method of the present disclosure is a method including ejecting the aqueous ink of the present disclosure described above from a recording head of an ink jet system to record an image on a recording medium. A system of ejecting the ink is, for example, a system involving applying mechanical energy to the ink or a system involving applying thermal energy to the ink. In the present disclosure, the system involving applying the thermal energy to the ink to eject the ink is particularly preferably adopted. The step of the ink jet recording method only needs to be a known step except that the ink of the present disclosure is used.

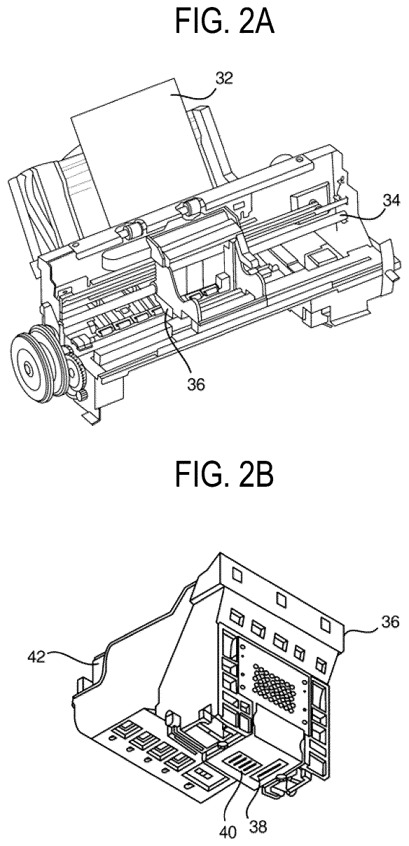

FIG. 2A and FIG. 2B are views for schematically illustrating an example of an ink jet recording apparatus to be used in the ink jet recording method of the present disclosure. FIG. 2A is a perspective view of the main portion of the ink jet recording apparatus and FIG. 2B is a perspective view of a head cartridge. A conveying unit (not shown) that conveys a recording medium 32 and a carriage shaft 34 are arranged in the ink jet recording apparatus. A head cartridge 36 may be mounted on the carriage shaft 34. The head cartridge 36 includes recording heads 38 and 40, and is formed so that an ink cartridge 42 may be set therein. While the head cartridge 36 is conveyed along the carriage shaft 34 in a main scanning direction, the ink (not shown) is ejected from the recording heads 38 and 40 toward the recording medium 32. Then, the recording medium 32 is conveyed by the conveying unit (not shown) in a sub-scanning direction. Thus, the image is recorded on the recording medium 32.

Any kind of recording medium may be used as the recording medium on which an image is to be recorded with the ink of the present disclosure. Recording media each having ink absorbency, for example, recording media having no coat layer such as plain paper and recording media each having a coat layer, such as glossy paper and matte paper, may be used. In addition, recording media each having low ink absorbency or no ink absorbency, for example, a printed sheet, coated paper, a resin sheet and a resin film may be used. The ink of the present disclosure may be suitably used for applications in which an ink is directly applied to such recording medium to record an image.

### EXAMPLES

The present disclosure is described in more detail below by way of Examples and Comparative Examples. However, the present disclosure is by no means limited to Examples below, and various modifications are possible without departing from the gist of the present disclosure. In the description of the amounts of components, “part(s)” and “%” are by mass unless otherwise specified.

### <Methods of Measuring Physical Property Values>

The methods for measuring the various physical properties are shown below. The measured physical properties are shown in Table 1 (Tables 1-1 to 1-9).

### (Glass Transition Temperature (Tg) of Resin)

A solid or powdery resin was prepared as a measurement sample, and a displacement temperature measured in conformity with JIS K 6240 with a differential scanning calorimeter (DSC) (product name: “DSC 2500”, manufactured by TA Instruments) was adopted as its glass transition temperature (Tg).

### (Determination of Whether or not Sample is Particle, Particle Diameter)

A liquid containing the sample was diluted with pure water to prepare a measurement sample in which the content of the sample was adjusted to about 1.0%. Then, the particle diameter (D₅₀) of a resin particle in the measurement sample was measured with a particle size distribution measuring device. Measurement conditions in this case are described below. A particle size distribution meter based on a dynamic light scattering method (product name: “NANOTRAC WAVE II-Q”, manufactured by MicrotracBEL) was used as the particle size distribution measuring device. When the presence of a particle having a particle diameter was recognized by the above-mentioned method, it was determined that the sample was a “particle” (was a “water dispersion liquid”), and when the presence of a particle having a particle diameter was not recognized, it was determined that the sample was not a “particle” (was an “aqueous solution”).

### [Measurement Conditions]

Set Zero: 30 seconds
Number of measurements: 3 times
Measurement time: 120 seconds
Shape: spherical
Refractive index: 1.5
Density: 1.0.

### (Surface Acid Group Amount of Resin Particle)

With regard to a sample obtained by adjusting the pH of a resin particle-containing liquid (aqueous resin particle dispersion liquid) to 12, the amount (μmol/g) of acid groups present on the particle surfaces of its resin particles per unit mass of the resin particles was measured by colloid titration utilizing a potential difference. A potentiometric automatic titrator (product name: “AT510”, manufactured by Kyoto Electronics Manufacturing Co., Ltd.) including a streaming potential titration unit (product name: “PCD-500”, manufactured by Kyoto Electronics Manufacturing Co., Ltd.) was used for the colloid titration. A 0.005 mol/L methyl glycol chitosan solution was used as a titration reagent.

### (Dissociation Rate of Surface Acid Groups of Resin Particle at pH of 9)

With regard to a sample obtained by adjusting the pH of a resin particle-containing liquid (aqueous resin particle dispersion liquid) to 9, the amount of acid groups that were dissociated with anionic properties on the surfaces of its resin particles was measured at a pH of 9 by colloid titration as in the surface acid group amount of the resin particles. The ratio of the amount of the acid groups dissociated with anionic properties at a pH of 9 to the surface acid group amount of the resin particles at a pH of 12 was adopted as the dissociation rate (%) of the surface acid groups of the resin particles at a pH of 9.

### (Amount of Ammonium Ion Inside Resin Particle)

For each resin particle dispersion liquid, a resin particle dispersion liquid before storage and a resin particle dispersion liquid stored for one month at a temperature of the glass transition temperature (Tg) of its resin particles+5° C. were prepared. Each dispersion liquid was treated with an ultracentrifuge (product name: “Optima MAX”, manufactured by Beckman Coulter, Inc.) at 80,000 rpm for 30 minutes so that its resin component was settled. The resultant supernatant liquid was adopted as a sample. The ammonium ion (NH₄⁺) concentration of the sample was measured with an ion chromatograph (product name: “Dionex ICS-6000”, manufactured by Thermo Fisher Scientific, Inc.). A difference between the NH₄⁺ concentrations obtained from the samples before and after the storage of the resin particle dispersion liquid was determined as the amount (μmol/g) of ammonium ions that was present inside the resin particles.

### <Production of Resin Particle Dispersion Liquids E-1 to E-55>

### [First Step]

235.0 Parts of deionized water were loaded into a flask including a dropping funnel, a stirring machine, a nitrogen-introducing tube, a temperature gauge and a reflux condenser. A mixed liquid obtained by mixing the respective components whose kinds and amounts (unit: part(s)) were shown in the column “Mixed liquid used in first step” column of Table 1 (Tables 1-1 to 1-9) was loaded into the dropping funnel. An amount corresponding to 14% of the total amount of the mixed liquid was dropped into the flask, and a temperature inside the flask was increased to 65° C. while a nitrogen gas was slowly blown thereinto, followed by the addition of 25.0 parts of a 4.0% potassium persulfate (KPS) aqueous solution as a polymerization initiator to start polymerization. After reaction heat due to the polymerization had subsided, the temperature inside the flask was set to 70° C., and the remainder of the mixed liquid and 90.0 parts of a 0.05% potassium persulfate aqueous solution were dropped thereinto over 140 minutes. After the completion of the dropping, the mixture was maintained at the temperature for 120 minutes. Thus, a first aqueous dispersion containing resin particles was obtained by an emulsion polymerization method.

### [Second Step]

A pH adjuster or buffer whose kind was shown in the column “Second step” of Table 1 was added to the first aqueous dispersion obtained in the above-mentioned first step to provide a second aqueous dispersion whose pH was adjusted to a value shown in the same column.

### [Third Step]

After the second aqueous dispersion after the second step had been placed at a temperature and for a holding time shown in the column “Third step” of Table 1, the content of its resin particles (solid content) was adjusted to 40%, and the aqueous dispersion was filtered with a 1 μm filter to provide each of aqueous resin particle dispersion liquids E-1 to E-55.

The meanings of abbreviations in Table 1 are described below.
St: Styrene
2EHA: 2-ethylhexyl acrylate
MMA: methyl methacrylate
BA: butyl acrylate
BMA: butyl methacrylate
CHMA: cyclohexyl methacrylate
AN: acrylonitrile
MAA: methacrylic acid
AA: acrylic acid
Light Ester P-1M: product name of 2-methacryloyloxyethyl acid phosphate manufactured by Kyoeisha Chemical Co., Ltd.
KH-10: product name “AQUALON KH-10” (manufactured by DKS Co., Ltd.; polyoxyethylene-1-(allyloxymethyl)alkyl ether sulfate ammonium salt, which is an anionic surfactant).
LATEMUL PD-420: product name of a non-reactive nonionic surfactant (polyoxyalkylene alkenyl ether) manufactured by Kao Corporation
SDS: sodium dodecyl sulfate
KOH: 8 mol/L potassium hydroxide aqueous solution.
NaOH: 10 mol/L sodium hydroxide aqueous solution
NH₃aq: 28% ammonia water
Buffer solution: 7.5% sodium hydrogen carbonate aqueous solution.

TABLE 1-1
Preparation conditions for resin particle dispersion liquids and characteristics of resin particles

| | | | Resin particle dispersion liquid | | | | | | |
|---|---|---|---|---|---|---|---|---|---|
| | | | E-1 | E-2 | E-3 | E-4 | E-5 | E-6 | E-7 |
| Mixed liquid | Ion-exchanged water | | 130.0 | 130.0 | 130.0 | 130.0 | 130.0 | 130.0 | 130.0 |
| used in first | Monomer | St | 198.4 | | | 144.0 | 198.4 | 182.5 | 198.4 |
| step (part(s)) | | 2EHA | 88.0 | | | | 88.0 | 88.0 | 88.0 |
| | | MMA | | 200.0 | | | | | |
| | | BA | | 86.4 | | 84.8 | | | |
| | | BMA | | | 198.4 | | | | |
| | | CHMA | | | 88.0 | | | | |
| | | AN | | | | 57.6 | | | |
| | | MAA | 19.2 | 19.2 | 19.2 | 19.2 | | | 19.2 |
| | | AA | | | | | 19.2 | | |
| | | Light Ester | | | | | | 35.1 | |
| | | P-1M | | | | | | | |
| | Surfactant | KH-10 | 14.4 | 14.4 | 14.4 | 14.4 | 14.4 | 14.4 | 14.4 |
| | | LATEMUL | | | | | | | |
| | | PD-420 | | | | | | | |
| | | SDS | | | | | | | |
| | Ammonium | Ammonium | 0.17 | 0.17 | 0.17 | 0.17 | 0.17 | 0.17 | 0.17 |
| | salt | chloride | | | | | | | |
| | | Ammonium | | | | | | | |
| | | sulfate | | | | | | | |
| Second step | pH | pH adjuster | KOH | KOH | KOH | KOH | KOH | KOH | KOH |
| | adjustment | pH after | 8.0 | 8.0 | 8.0 | 8.0 | 8.0 | 8.0 | 8.0 |
| | | adjustment | | | | | | | |
| Third step | Heat | Temperature | 80 | 80 | 80 | 80 | 80 | 80 | 80 |
| | treatment | (° C.) | | | | | | | |
| | | Holding | 2 | 2 | 2 | 2 | 2 | 2 | 24 |
| | | time (hr) | | | | | | | |

| | | | | | | | | |
|---|---|---|---|---|---|---|---|---|
| Characteristic | Surface acid group amount at | 300 | 300 | 300 | 300 | 300 | 300 | 300 |
| | pH of 12 (μmol/g) | | | | | | | |
| | Dissociation rate of surface | 88 | 88 | 88 | 88 | 88 | 88 | 88 |
| | acid groups at pH of 9 (%) | | | | | | | |
| | Amount of ammonium ion | 10 | 10 | 10 | 10 | 10 | 10 | 2 |
| | (μmol/g) | | | | | | | |
| | Carboxylic acid | 13 | 13 | 13 | 13 | 16 | 0 | 13 |
| | group-to-sulfonic acid | | | | | | | |
| | group molar ratio | | | | | | | |
| | Tg (° C.) | 62 | 62 | 62 | 62 | 58 | 65 | 62 |
| | D₅₀ (nm) | 100 | 100 | 100 | 100 | 100 | 100 | 100 |

TABLE 1-2
Preparation conditions for resin particle dispersion liquids and characteristics of resin particles

| | | | Resin particle dispersion liquid | | | | | | |
|---|---|---|---|---|---|---|---|---|---|
| | | | E-8 | E-9 | E-10 | E-11 | E-12 | E-13 | E-14 |
| Mixed liquid | Ion-exchanged water | | 130.0 | 130.0 | 130.0 | 130.0 | 130.0 | 130.0 | 130.0 |
| used in first | Monomer | St | 198.4 | 198.4 | 206.4 | 179.2 | 198.4 | 198.4 | 198.4 |
| step (part(s)) | | 2EHA | 88.0 | 88.0 | 80.0 | 107.2 | 88.0 | 88.0 | 88.0 |
| | | MMA | | | | | | | |
| | | BA | | | | | | | |
| | | BMA | | | | | | | |
| | | CHMA | | | | | | | |
| | | AN | | | | | | | |
| | | MAA | 19.2 | 19.2 | 19.2 | 19.2 | 19.2 | 19.2 | 19.2 |
| | | AA | | | | | | | |
| | | Light Ester | | | | | | | |
| | | P-1M | | | | | | | |
| | Surfactant | KH-10 | 14.4 | 14.4 | 14.4 | 14.4 | 14.4 | 14.4 | 14.4 |
| | | LATEMUL | | | | | | | |
| | | PD-420 | | | | | | | |
| | | SDS | | | | | | | |
| | Ammonium | Ammonium | 0.17 | | 0.17 | 0.17 | 0.17 | 0.17 | 0.17 |
| | salt | chloride | | | | | | | |
| | | Ammonium | | 0.21 | | | | | |
| | | sulfate | | | | | | | |
| Second step | pH | pH adjuster | KOH | KOH | KOH | KOH | KOH | KOH | KOH |
| | adjustment | pH after | 8.0 | 8.0 | 8.0 | 8.0 | 8.0 | 8.0 | 8.0 |
| | | adjustment | | | | | | | |
| Third step | Heat | Temperature | 80 | 80 | 75 | 85 | 80 | 80 | 80 |
| | treatment | (° C.) | | | | | | | |
| | | Holding | 0.5 | 2 | 2 | 2 | 12 | 6 | 1 |
| | | time (hr) | | | | | | | |

| | | | | | | | | |
|---|---|---|---|---|---|---|---|---|
| Characteristic | Surface acid group amount at | 300 | 300 | 100 | 400 | 300 | 300 | 300 |
| | pH of 12 (μmol/g) | | | | | | | |
| | Dissociation rate of surface | 88 | 88 | 88 | 88 | 88 | 88 | 88 |
| | acid groups at pH of 9 (%) | | | | | | | |
| | Amount of ammonium ion | 10 | 10 | 10 | 10 | 4 | 5 | 50 |
| | (μmol/g) | | | | | | | |
| | Carboxylic acid | 13 | 13 | 13 | 13 | 13 | 13 | 13 |
| | group-to-sulfonic acid | | | | | | | |
| | group molar ratio | | | | | | | |
| | Tg (° C.) | 62 | 62 | 70 | 52 | 62 | 62 | 62 |
| | D₅₀ (nm) | 100 | 100 | 100 | 100 | 100 | 100 | 100 |

TABLE 1-3
Preparation conditions for resin particle dispersion liquids and characteristics of resin particles

| | | | Resin particle dispersion liquid | | | | | | |
|---|---|---|---|---|---|---|---|---|---|
| | | | E-15 | E-16 | E-17 | E-18 | E-19 | E-20 | E-21 |
| Mixed liquid | Ion-exchanged water | | 130.0 | 130.0 | 130.0 | 130.0 | 130.0 | 130.0 | 130.0 |
| used in first | Monomer | St | 198.4 | 192.0 | 195.2 | 202.6 | 203.8 | 171.2 | 179.2 |
| step (part(s)) | | 2EHA | 88.0 | 88.0 | 88.0 | 88.0 | 88.0 | 115.2 | 107.2 |
| | | MMA | | | | | | | |
| | | BA | | | | | | | |
| | | BMA | | | | | | | |
| | | CHMA | | | | | | | |
| | | AN | | | | | | | |
| | | MAA | 19.2 | 19.2 | 19.2 | 19.2 | 19.2 | 19.2 | 19.2 |
| | | AA | | | | | | | |
| | | Light Ester | | | | | | | |
| | | P-1M | | | | | | | |
| | Surfactant | KH-10 | | 20.8 | 17.6 | 10.2 | 9.0 | 14.4 | 14.4 |
| | | LATEMUL | 14.4 | | | | | | |
| | | PD-420 | | | | | | | |
| | | SDS | | | | | | | |
| | Ammonium | Ammonium | 0.17 | 0.17 | 0.17 | 0.17 | 0.17 | 0.17 | 0.17 |
| | salt | chloride | | | | | | | |
| | | Ammonium | | | | | | | |
| | | sulfate | | | | | | | |
| Second step | pH | pH adjuster | KOH | KOH | KOH | KOH | KOH | KOH | KOH |
| | adjustment | pH after | 8.0 | 8.0 | 8.0 | 8.0 | 8.0 | 8.0 | 8.0 |
| | | adjustment | | | | | | | |
| Third step | Heat | Temperature | 80 | 80 | 80 | 80 | 80 | 70 | 70 |
| | treatment | (° C.) | | | | | | | |
| | | Holding | 2 | 2 | 2 | 2 | 2 | 2 | 2 |
| | | time (hr) | | | | | | | |

| | | | | | | | | |
|---|---|---|---|---|---|---|---|---|
| Characteristic | Surface acid group amount at | 270 | 350 | 320 | 200 | 250 | 320 | 320 |
| | pH of 12 (μmol/g) | | | | | | | |
| | Dissociation rate of surface | 88 | 88 | 88 | 88 | 88 | 88 | 88 |
| | acid groups at pH of 9 (%) | | | | | | | |
| | Amount of ammonium ion | 10 | 10 | 10 | 10 | 10 | 10 | 10 |
| | (μmol/g) | | | | | | | |
| | Carboxylic acid | — | 9 | 11 | 18 | 21 | 13 | 13 |
| | group-to-sulfonic acid | | | | | | | |
| | group molar ratio | | | | | | | |
| | Tg (° C.) | 62 | 60 | 60 | 64 | 64 | 48 | 52 |
| | D₅₀ (nm) | 100 | 80 | 90 | 150 | 180 | 100 | 100 |

TABLE 1-4
Preparation conditions for resin particle dispersion liquids and characteristics of resin particles

| | | | Resin particle dispersion liquid | | | | | |
|---|---|---|---|---|---|---|---|---|
| | | | E-22 | E-23 | E-24 | E-25 | E-26 | E-27 |
| Mixed liquid | Ion-exchanged water | | 130.0 | 130.0 | 130.0 | 130.0 | 130.0 | 130.0 |
| used in first | Monomer | St | 222.4 | 228.8 | 198.4 | 198.4 | 198.4 | 198.4 |
| step (part(s)) | | 2EHA | 64.0 | 57.6 | 88.0 | 88.0 | 88.0 | 88.0 |
| | | MMA | | | | | | |
| | | BA | | | | | | |
| | | BMA | | | | | | |
| | | CHMA | | | | | | |
| | | AN | | | | | | |
| | | MAA | 19.2 | 19.2 | 19.2 | 19.2 | 19.2 | 19.2 |
| | | AA | | | | | | |
| | | Light Ester | | | | | | |
| | | P-1M | | | | | | |
| | Surfactant | KH-10 | 14.4 | 14.4 | 14.4 | 14.4 | 14.4 | 14.4 |
| | | LATEMUL | | | | | | |
| | | PD-420 | | | | | | |
| | | SDS | | | | | | |
| | Ammonium | Ammonium | 0.17 | 0.17 | 0.17 | 0.17 | 0.17 | 0.17 |
| | salt | chloride | | | | | | |
| | | Ammonium | | | | | | |
| | | sulfate | | | | | | |
| Second step | pH | pH adjuster | KOH | KOH | KOH | KOH | KOH | KOH |
| | adjustment | pH after | 8.0 | 8.0 | 8.0 | 8.0 | 8.0 | 8.0 |
| | | adjustment | | | | | | |
| Third step | Heat | Temperature | 85 | 90 | 65 | 65 | 70 | 90 |
| | treatment | (° C.) | | | | | | |
| | | Holding | 2 | 2 | 0.5 | 2 | 2 | 1 |
| | | time (hr) | | | | | | |

| | | | | | | | |
|---|---|---|---|---|---|---|---|
| Characteristic | Surface acid group amount at | 180 | 180 | 300 | 300 | 300 | 300 |
| | pH of 12 (μmol/g) | | | | | | |
| | Dissociation rate of surface | 88 | 88 | 78 | 80 | 84 | 92 |
| | acid groups at pH of 9 (%) | | | | | | |
| | Amount of ammonium ion | 10 | 10 | 10 | 10 | 10 | 10 |
| | (μmol/g) | | | | | | |
| | Carboxylic acid | 13 | 13 | 13 | 13 | 13 | 13 |
| | group-to-sulfonic acid | | | | | | |
| | group molar ratio | | | | | | |
| | Tg (° C.) | 78 | 82 | 62 | 62 | 62 | 62 |
| | D₅₀ (nm) | 100 | 100 | 100 | 100 | 100 | 100 |

TABLE 1-5
Preparation conditions for resin particle dispersion liquids and characteristics of resin particles

| | | | Resin particle dispersion liquid | | | | | |
|---|---|---|---|---|---|---|---|---|
| | | | E-28 | E-29 | E-30 | E-31 | E-32 | E-33 |
| Mixed liquid | Ion-exchanged water | | 130.0 | 130.0 | 130.0 | 130.0 | 130.0 | 130.0 |
| used in first | Monomer | St | 198.4 | 201.6 | 200.6 | 193.6 | 192.0 | 201.6 |
| step (part(s)) | | 2EHA | 88.0 | 88.0 | 88.0 | 88.0 | 88.0 | 88.0 |
| | | MMA | | | | | | |
| | | BA | | | | | | |
| | | BMA | | | | | | |
| | | CHMA | | | | | | |
| | | AN | | | | | | |
| | | MAA | 19.2 | 16.0 | 17.0 | 24.0 | 25.6 | 16.0 |
| | | AA | | | | | | |
| | | Light Ester | | | | | | |
| | | P-1M | | | | | | |
| | Surfactant | KH-10 | 14.4 | 14.4 | 14.4 | 14.4 | 14.4 | 14.4 |
| | | LATEMUL | | | | | | |
| | | PD-420 | | | | | | |
| | | SDS | | | | | | |
| | Ammonium | Ammonium | 0.17 | 0.17 | 0.17 | 0.17 | 0.17 | 0.17 |
| | salt | chloride | | | | | | |
| | | Ammonium | | | | | | |
| | | sulfate | | | | | | |
| Second step | pH | pH adjuster | KOH | KOH | KOH | KOH | KOH | KOH |
| | adjustment | pH after | 8.0 | 8.0 | 8.0 | 8.0 | 8.0 | 8.0 |
| | | adjustment | | | | | | |
| Third step | Heat | Temperature | 90 | 80 | 80 | 80 | 80 | 65 |
| | treatment | (° C.) | | | | | | |
| | | Holding | 2 | 2 | 2 | 2 | 2 | 2 |
| | | time (hr) | | | | | | |

| | | | | | | | |
|---|---|---|---|---|---|---|---|
| Characteristic | Surface acid group amount at | 300 | 230 | 250 | 350 | 360 | 230 |
| | pH of 12 (μmol/g) | | | | | | |
| | Dissociation rate of surface | 93 | 88 | 88 | 88 | 88 | 82 |
| | acid groups at pH of 9 (%) | | | | | | |
| | Amount of ammonium ion | 10 | 10 | 10 | 10 | 10 | 10 |
| | (μmol/g) | | | | | | |
| | Carboxylic acid | 13 | 11 | 12 | 16 | 17 | 11 |
| | group-to-sulfonic acid | | | | | | |
| | group molar ratio | | | | | | |
| | Tg (° C.) | 62 | 62 | 62 | 62 | 62 | 62 |
| | D₅₀ (nm) | 100 | 100 | 100 | 100 | 100 | 100 |

TABLE 1-6
Preparation conditions for resin particle dispersion liquids and characteristics of resin particles

| | | | Resin particle dispersion liquid | | | | | |
|---|---|---|---|---|---|---|---|---|
| | | | E-34 | E-35 | E-36 | E-37 | E-38 | E-39 |
| Mixed liquid | Ion-exchanged water | | 130.0 | 130.0 | 130.0 | 130.0 | 130.0 | 130.0 |
| used in first | Monomer | St | 192.0 | 187.2 | 193.6 | 201.6 | 203.2 | 198.4 |
| step (part(s)) | | 2EHA | 88.0 | 88.0 | 88.0 | 88.0 | 88.0 | 88.0 |
| | | MMA | | | | | | |
| | | BA | | | | | | |
| | | BMA | | | | | | |
| | | CHMA | | | | | | |
| | | AN | | | | | | |
| | | MAA | 25.6 | 22.4 | 19.2 | 19.2 | 19.2 | 19.2 |
| | | AA | | | | | | |
| | | Light Ester | | | | | | |
| | | P-1M | | | | | | |
| | Surfactant | KH-10 | 14.4 | 22.4 | 19.2 | 11.2 | 9.6 | 14.4 |
| | | LATEMUL | | | | | | |
| | | PD-420 | | | | | | |
| | | SDS | | | | | | |
| | Ammonium | Ammonium | 0.17 | 0.17 | 0.17 | 0.17 | 0.17 | 0.17 |
| | salt | chloride | | | | | | |
| | | Ammonium | | | | | | |
| | | sulfate | | | | | | |
| Second step | pH | pH adjuster | KOH | KOH | KOH | KOH | KOH | NaOH |
| | adjustment | pH after | 8.0 | 8.0 | 8.0 | 8.0 | 8.0 | 8.0 |
| | | adjustment | | | | | | |
| Third step | Heat | Temperature | 90 | 80 | 80 | 80 | 80 | 80 |
| | treatment | (° C.) | | | | | | |
| | | Holding | 2 | 2 | 2 | 2 | 2 | 2 |
| | | time (hr) | | | | | | |

| | | | | | | | |
|---|---|---|---|---|---|---|---|
| Characteristic | Surface acid group amount at | 360 | 400 | 380 | 130 | 100 | 300 |
| | pH of 12 (μmol/g) | | | | | | |
| | Dissociation rate of surface | 93 | 86 | 86 | 88 | 88 | 88 |
| | acid groups at pH of 9 (%) | | | | | | |
| | Amount of ammonium ion | 10 | 10 | 10 | 10 | 10 | 10 |
| | (μmol/g) | | | | | | |
| | Carboxylic acid | 17 | 10 | 10 | 17 | 20 | 13 |
| | group-to-sulfonic acid | | | | | | |
| | group molar ratio | | | | | | |
| | Tg (° C.) | 62 | 58 | 60 | 62 | 62 | 62 |
| | D₅₀ (nm) | 100 | 45 | 50 | 200 | 220 | 100 |

TABLE 1-7
Preparation conditions for resin particle dispersion liquids and characteristics of resin particles

| | | | Resin particle dispersion liquid | | | | | |
|---|---|---|---|---|---|---|---|---|
| | | | E-40 | E-41 | E-42 | E-43 | E-44 | E-45 |
| Mixed liquid | Ion-exchanged water | | 130.0 | 130.0 | 130.0 | 130.0 | 130.0 | 130.0 |
| used in first | Monomer | St | 198.4 | 198.4 | 198.4 | 198.4 | 198.4 | 198.4 |
| step (part(s)) | | 2EHA | 88.0 | 88.0 | 88.0 | 88.0 | 88.0 | 88.0 |
| | | MMA | | | | | | |
| | | BA | | | | | | |
| | | BMA | | | | | | |
| | | CHMA | | | | | | |
| | | AN | | | | | | |
| | | MAA | 19.2 | 19.2 | 19.2 | 19.2 | 19.2 | 19.2 |
| | | AA | | | | | | |
| | | Light Ester | | | | | | |
| | | P-1M | | | | | | |
| | Surfactant | KH-10 | 14.4 | 14.4 | 14.4 | 14.4 | 14.4 | |
| | | LATEMUL | | | | | | 14.4 |
| | | PD-420 | | | | | | |
| | | SDS | | | | | | |
| | Ammonium | Ammonium | 0.17 | 0.17 | 0.17 | 0.17 | 0.17 | 0.17 |
| | salt | chloride | | | | | | |
| | | Ammonium | | | | | | |
| | | sulfate | | | | | | |
| Second step | pH | pH | Buffer | KOH | KOH | KOH | KOH | KOH |
| | adjustment | adjuster | solution | | | | | |
| | | pH after | 8.0 | 7.5 | 9.5 | 8.0 | 8.0 | 8.0 |
| | | adjustment | | | | | | |
| Third step | Heat | Temperature | 80 | 80 | 80 | 65 | 80 | 80 |
| | treatment | (° C.) | | | | | | |
| | | Holding | 2 | 2 | 2 | 2 | 24 | 2 |
| | | time (hr) | | | | | | |

| | | | | | | | |
|---|---|---|---|---|---|---|---|
| Characteristic | Surface acid group amount at | 300 | 300 | 300 | 300 | 300 | 150 |
| | pH of 12 (μmol/g) | | | | | | |
| | Dissociation rate of surface | 88 | 88 | 88 | 88 | 88 | 78 |
| | acid groups at pH of 9 (%) | | | | | | |
| | Amount of ammonium ion | 10 | 10 | 10 | 10 | 10 | 4 |
| | (μmol/g) | | | | | | |
| | Carboxylic acid | 13 | 13 | 13 | 13 | 13 | — |
| | group-to-sulfonic acid | | | | | | |
| | group molar ratio | | | | | | |
| | Tg (° C.) | 62 | 62 | 62 | 62 | 62 | 82 |
| | D₅₀ (nm) | 100 | 100 | 100 | 100 | 100 | 220 |

TABLE 1-8
Preparation conditions for resin particle dispersion liquids and characteristics of resin particles

| | | | Resin particle dispersion liquid | | | | | |
|---|---|---|---|---|---|---|---|---|
| | | | E-46 | E-47 | E-48 | E-49 | E-50 | E-51 |
| Mixed liquid | Ion-exchanged water | | 130.0 | 130.0 | 130.0 | 130.0 | 130.0 | 130.0 |
| used in first | Monomer | St | 212.8 | 198.4 | 198.4 | 198.4 | 198.4 | 232.0 |
| step (part(s)) | | 2EHA | 88.0 | 88.0 | 88.0 | 88.0 | 88.0 | 88.0 |
| | | MMA | | | | | | |
| | | BA | | | | | | |
| | | BMA | | | | | | |
| | | CHMA | | | | | | |
| | | AN | | | | | | |
| | | MAA | 19.2 | 19.2 | 19.2 | 19.2 | 19.2 | |
| | | AA | | | | | | |
| | | Light Ester | | | | | | |
| | | P-1M | | | | | | |
| | Surfactant | KH-10 | | 14.4 | 14.4 | 14.4 | 14.4 | |
| | | LATEMUL | | | | | | |
| | | PD-420 | | | | | | |
| | | SDS | 3.6 | | | | | 3.6 |
| | Ammonium | Ammonium | | 0.02 | 1.37 | 0.17 | 0.17 | |
| | salt | chloride | | | | | | |
| | | Ammonium | | | | | | |
| | | sulfate | | | | | | |
| Second step | pH | pH adjuster | NH₃aq | KOH | KOH | KOH | KOH | KOH |
| | adjustment | pH after | 8.0 | 8.0 | 8.0 | 8.0 | 8.0 | 8.0 |
| | | adjustment | | | | | | |
| Third step | Heat | Temperature | 80 | 90 | 80 | 80 | 80 | 80 |
| | treatment | (° C.) | | | | | | |
| | | Holding | 2 | 2 | 2 | 2 | 2 | 2 |
| | | time (hr) | | | | | | |

| | | | | | | | |
|---|---|---|---|---|---|---|---|
| Characteristic | Surface acid group amount at | 300 | 300 | 300 | 420 | 90 | — |
| | pH of 12 (μmol/g) | | | | | | |
| | Dissociation rate of surface | 78 | 88 | 88 | 88 | 88 | — |
| | acid groups at pH of 9 (%) | | | | | | |
| | Amount of ammonium ion | 0 | 1 | 80 | 10 | 10 | None |
| | (μmol/g) | | | | | | |
| | Carboxylic acid | — | 13 | 13 | 18 | 4 | — |
| | group-to-sulfonic acid | | | | | | |
| | group molar ratio | | | | | | |
| | Tg (° C.) | 62 | 62 | 62 | 58 | 62 | 60 |
| | D₅₀ (nm) | 100 | 100 | 100 | 100 | 100 | 100 |

TABLE 1-9
Preparation conditions for resin particle dispersion liquids and characteristics of resin particles

| | | | Resin particle dispersion liquid | | | | | |
|---|---|---|---|---|---|---|---|---|
| | | | E-52 | E-53 | E-54 | E-55 | E-56 | E-57 |
| Mixed liquid | Ion-exchanged water | | 130.0 | 130.0 | 130.0 | 130.0 | 130.0 | 130.0 |
| used in first | Monomer | St | 198.4 | 198.4 | 198.4 | 198.4 | 198.4 | 198.4 |
| step (part(s)) | | 2EHA | 88.0 | 88.0 | 88.0 | 88.0 | 88.0 | 88.0 |
| | | MMA | | | | | | |
| | | BA | | | | | | |
| | | BMA | | | | | | |
| | | CHMA | | | | | | |
| | | AN | | | | | | |
| | | MAA | 19.2 | 19.2 | 19.2 | 19.2 | 19.2 | 19.2 |
| | | AA | | | | | | |
| | | Light Ester | | | | | | |
| | | P-1M | | | | | | |
| | Surfactant | KH-10 | 14.4 | 14.4 | 14.4 | 14.4 | 14.4 | 14.4 |
| | | LATEMUL | | | | | | |
| | | PD-420 | | | | | | |
| | | SDS | | | | | | |
| | Ammonium | Ammonium | 0.17 | 0.17 | 0.17 | 0.17 | 0.17 | 0.17 |
| | salt | chloride | | | | | | |
| | | Ammonium | | | | | | |
| | | sulfate | | | | | | |
| Second step | pH | pH adjuster | KOH | KOH | KOH | KOH | KOH | KOH |
| | adjustment | pH after | 7.2 | 9.7 | 8.0 | 8.0 | 8.0 | 8.0 |
| | | adjustment | | | | | | |
| Third step | Heat | Temperature | 80 | 80 | 50 | 80 | Room | Neutralization |
| | treatment | (° C.) | | | | | temperature | after heating |
| | | Holding | 2 | 2 | 2 | 32 | — | 2 |
| | | time (hr) | | | | | | |

| | | | | | | | |
|---|---|---|---|---|---|---|---|
| Characteristic | Surface acid group | 90 | 420 | 300 | 300 | 300 | 300 |
| | amount at pH of 12 | | | | | | |
| | (μmol/g) | | | | | | |
| | Dissociation rate of | 88 | 88 | 88 | 88 | 88 | 88 |
| | surface acid groups | | | | | | |
| | at pH of 9 (%) | | | | | | |
| | Amount of ammonium | 10 | 10 | 65 | 1 | 80 | 80 |
| | ion (μmol/g) | | | | | | |
| | Carboxylic acid | 13 | 13 | 13 | 13 | 13 | 13 |
| | group-to-sulfonic acid | | | | | | |
| | group molar ratio | | | | | | |
| | Tg (° C.) | 62 | 62 | 62 | 62 | 62 | 62 |
| | D₅₀ (nm) | 100 | 100 | 100 | 100 | 100 | 100 |

### <Production of Resin Particle Dispersion Liquid E-56>

A procedure up to the “Second Step” was performed by the same method as that for the above-mentioned resin particle dispersion liquids E-1 to E-55. After that, the content of the resin particles (solid content) of the resultant aqueous dispersion was adjusted to 40%, and the aqueous dispersion was filtered with a 1 μm filter to provide a resin particle dispersion liquid E-56.

### <Production of Resin Particle Dispersion Liquid E-57>

The “First Step” was performed by the same manner as that for the above-mentioned resin particle dispersion liquids E-1 to E-55. After that, the following was repeated three times: while the temperature of the resultant liquid was held at 80° C., 10.0 parts of a 4.0% potassium persulfate (KPS) aqueous solution was added thereto; and the temperature was held for 60 minutes. After that, potassium hydroxide was added to the mixture to adjust its pH to 8, and the content of its resin particles (solid content) was adjusted to 40%, followed by filtration with a 1 μm filter. Thus, a resin particle dispersion liquid E-57 was obtained.

### <Preparation of Pigment Dispersion Liquids P-1 to P-3>

A mixture of 10.0 parts of a pigment whose kind was shown in Table 2, 20.0 parts of a resin-containing liquid, and 70.0 parts of ion-exchanged water was loaded into a batch-type vertical sand mill (manufactured by AIMEX Co., Ltd.) filled with 200 parts of zirconia beads each having a diameter of 0.3 mm, and was dispersed for a predetermined time. The abbreviations of the kinds of pigments shown in Table 2 each have the following meaning: “NIPex90”: the product name of carbon black manufactured by Orion Engineered Carbons; “PB 15:3”: C.I. Pigment Blue 15:3; and “PR 122”: C.I. Pigment Red 122. An aqueous solution having a resin content of 30.0%, which was obtained by dissolving a water-soluble resin in water containing potassium hydroxide in an amount equimolar to the acid value of the resin, was used as the resin-containing liquid. The water-soluble resin used in this case is a styrene-ethyl acrylate-acrylic acid copolymer having an acid value of 167 mgKOH/g and a weight average molecular weight of 10,000. After that, centrifugal separation was performed to remove a coarse particle, and pressure filtration was performed with a microfilter having a pore size of 3.0 μm (manufactured by FUJIFILM Corporation), followed by the addition of an appropriate amount of deionized water to adjust the content of the pigment dispersion liquid.

Thus, there were obtained pigment dispersion liquids P-1 to P-3 in each of which the content of the pigment was 10.0% and the content of the water-soluble resin (resin dispersant) was 6.0%. The kinds of the pigments used at the time of the preparation of the pigment dispersion liquids P-1 to P-3 and the cumulative 50% particle diameters (D₅₀) of the volume-based particle size distributions of the resultant pigment dispersion liquids are shown in Table 2.

### <Preparation of Pigment Dispersion Liquid P-4>

A solution obtained by dissolving 5.0 g of concentrated hydrochloric acid in 5.5 g of water was cooled to 5° C., and 1.6 g of 4-aminophthalic acid was added to the solution in the state. A vessel containing the solution was loaded into an ice bath, and while the solution was stirred and its temperature was held at 10° C. or less, a solution obtained by dissolving 1.8 g of sodium nitrite in 9.0 g of ion-exchanged water at 5° C. was added thereto. After the mixture was stirred for 15 minutes, 6.0 g of carbon black (product name: “NIPex90”, manufactured by Orion Engineered Carbons) was added thereto under stirring.

The mixture was further stirred for 15 minutes to provide a slurry. The resultant slurry was filtered with filter paper (product name: “standard filter paper No. 2”, manufactured by ADVANTEC), and its particle was sufficiently washed with water and dried in an oven at 110° C. After that, sodium ions were replaced with potassium ions by an ion exchange method. Thus, there was obtained a pigment dispersion liquid P-4, which contained a self-dispersed pigment, in which —C₆H₃—(COOK) 2 groups were bonded to the particle surfaces of the carbon black, and in which the content of the self-dispersed pigment was 10.0%. The kind of the pigment used at the time of the preparation of the pigment dispersion liquid P-4 and the D₅₀ of the resultant pigment dispersion liquid P-4 are shown in Table 2.

TABLE 2
Kinds of pigment dispersion liquids

| Pigment dispersion | Pigment | Physical property |
|---|---|---|
| liquid | Kind | D₅₀ (nm) |
| P-1 | NIPex90 | 80 |
| P-2 | PB15:3 | 90 |
| P-3 | PR122 | 120 |
| P-4 | NIPex90 | 80 |

### <Preparation of Ink>

### Examples 1 to 60 and Comparative Examples 1 to 12

Each ink was prepared by: mixing the following respective components; adjusting the pH of the mixture to a value shown in Table 3 (Table 3-1 and Table 3-2) also by using 8 mol/L potassium hydroxide; sufficiently stirring the mixture; and then subjecting the mixture to pressure filtration with a microfilter having a pore size of 2.5 μm. Of the following components, “Acetylenol E100” is the product name of a nonionic surfactant (manufactured by Kawaken Fine Chemicals Co., Ltd.). The kinds of resin particle dispersion liquids and pigment dispersion liquids used for the inks, and the contents of resin particles and pigments in the inks are shown in Table 3. The physical properties of the resin particles in the inks (the glass transition temperature of the resin, the particle diameter of the resin particles, the surface acid groups amount of the resin particles, the dissociation rate of surface acid groups of the resin particles at pH of 9, and the amount of ammonium ion inside the resin particles) are the same as those of the resin particle dispersion liquids used.
Resin particle dispersion liquid: Its kind is shown in Table 3 and its amount is such that the content (%) of its resin particles is a value shown in Table 3.
Pigment dispersion liquid: Its kind is shown in Table 3 and its amount is such that the content (%) of its pigment is a value shown in Table 3.
Glycerin: 5.0%
Triethylene glycol: 10.0%
Acetylenol E100: 0.1%
8 mol/L-potassium hydroxide: appropriate amount
Ion-exchanged water: such a residual amount (%) that the total of components becomes 100.0%.

### <Evaluation>

In the present disclosure, the levels “A” and “B” were defined as acceptable levels, and the level “C” was defined as an unacceptable level in evaluation criteria for each item shown below. In the following image clarity evaluation, in the case where a clear difference between the inks was recognized even within the same evaluation criteria, a relatively excellent ink out of the inks each evaluated as “A” was evaluated as “AA”, and a relatively poor ink out of the inks each evaluated as “B” was evaluated as “B−”. The evaluation results are shown in Table 3.

### (Storage Stability)

Each produced resin particle dispersion liquid was load into a closed container made of polytetrafluoroethylene and stored at 60° C. for 3 months. The viscosity η₁ (mPa·s) of the resin particle dispersion liquid before the storage and the viscosity η₂ (mPa·s) of the resin particle dispersion liquid after the storage were measured. In addition, the change rate P (%) of the viscosity of the resin particle dispersion liquid was calculated in accordance with the following equation: change rate P={(η₂−η₁)/η₁}×100(%). The viscosity was measured by using a rotational viscometer (product name: “E-type viscometer”, manufactured by Toki Sangyo Co., Ltd.) under the conditions of 25° C., a rotor 48′×R24 and a number of revolutions of 50 rpm. Then, the storage stability of the resin particle dispersion liquid was evaluated in accordance with the following evaluation criteria. A larger value of the change rate P means lower storage stability of the resin particle dispersion liquid because of the following reason: the dispersed state of its resin particles becomes unstable, and hence their particle diameters increase or the resin particles aggregate to increase the viscosity of the resin particle dispersion liquid.
A: The change rate P was less than 5%.
B: The change rate P was 5% or more to less than 10%.
C: The change rate P was 10% or more.

In addition, the storage stability of each ink was also evaluated in the same manner as above, except that ink was used instead of the resin particle dispersion liquid. As a result, the evaluation results for the storage stability of each ink were the same as those for the resin particle dispersion used in each ink.

### (Image Clarity)

Each prepared ink was loaded into an ink cartridge. The ink cartridge filled with the ink was set in an ink jet recording apparatus (product name: “PIXUS iP3100”, manufactured by CANON KABUSHIKI KAISHA) including a recording head that ejected an ink through the action of thermal energy and a heat-fixing unit. In the Examples, the recording duty of a solid image recorded under the following condition is defined as 100%: one ink droplet having a volume of 5 pL per drop is applied to a unit area measuring 1/1,200 inch by 1/1,200 inch. A solid image (recording duty: 100%) measuring 200 mm by 200 mm was recorded on a recording medium having a coated layer (product name: “Aurora Coat”, manufactured by Nippon Paper Industries Co., Ltd.) by using the above-mentioned ink jet recording apparatus in which the temperature of the heat-fixing unit was set to 80° C. After the recorded solid image had been left for 24 hours, the image was irradiated with light at an angle of 45° from a distance of 2 m by using two fluorescent lamps arranged in parallel at an interval of 10 cm (illumination angle: 45°). The image clarity of the image was evaluated in accordance with the following evaluation criteria by visually observing the shapes of the fluorescent lamps projected on the image from an angle of 45° (observation angle: 45°).
A: A boundary between the two projected fluorescent lamps was recognizable, and no blurring was observed at an edge thereof.
B: A boundary between the two projected fluorescent lamps was recognizable, but blurring was observed at an edge thereof.
C: A boundary between the two projected fluorescent lamps was unrecognizable.

TABLE 3-1
Evaluation conditions and evaluation results

| | | Resin particle | | | | | | | |
|---|---|---|---|---|---|---|---|---|---|
| | | dispersion liquid | | Pigment | | Ink | | | |
| | | | Content | dispersion liquid | | Mass ratio | | | |
| | | | of resin | | Content of | of resin | | Evaluation result | |
| | | | particles | | pigment | particles | pH | Storage | Image |
| | | Kind | (%) | Kind | (%) | to pigment | (—) | stability | clarity |
| Example | 1 | E-1 | 8.0 | P-1 | 4.0 | 2.0 | 8.5 | A | AA |
| | 2 | E-2 | 8.0 | P-1 | 4.0 | 2.0 | 8.5 | A | AA |
| | 3 | E-3 | 8.0 | P-1 | 4.0 | 2.0 | 8.5 | A | AA |
| | 4 | E-4 | 8.0 | P-1 | 4.0 | 2.0 | 8.5 | A | AA |
| | 5 | E-5 | 8.0 | P-1 | 4.0 | 2.0 | 8.5 | A | AA |
| | 6 | E-6 | 8.0 | P-1 | 4.0 | 2.0 | 8.5 | B | A |
| | 7 | E-7 | 8.0 | P-1 | 4.0 | 2.0 | 8.5 | B | A |
| | 8 | E-8 | 8.0 | P-1 | 4.0 | 2.0 | 8.5 | A | B |
| | 9 | E-9 | 8.0 | P-1 | 4.0 | 2.0 | 8.5 | A | AA |
| | 10 | E-10 | 8.0 | P-1 | 4.0 | 2.0 | 8.5 | B | A |
| | 11 | E-11 | 8.0 | P-1 | 4.0 | 2.0 | 8.5 | A | B |
| | 12 | E-12 | 8.0 | P-1 | 4.0 | 2.0 | 8.5 | B | A |
| | 13 | E-13 | 8.0 | P-1 | 4.0 | 2.0 | 8.5 | A | A |
| | 14 | E-14 | 8.0 | P-1 | 4.0 | 2.0 | 8.5 | A | A |
| | 15 | E-15 | 8.0 | P-1 | 4.0 | 2.0 | 8.5 | A | B |
| | 16 | E-16 | 8.0 | P-1 | 4.0 | 2.0 | 8.5 | B | A |
| | 17 | E-17 | 8.0 | P-1 | 4.0 | 2.0 | 8.5 | A | A |
| | 18 | E-18 | 8.0 | P-1 | 4.0 | 2.0 | 8.5 | A | A |
| | 19 | E-19 | 8.0 | P-1 | 4.0 | 2.0 | 8.5 | A | B |
| | 20 | E-20 | 8.0 | P-1 | 4.0 | 2.0 | 8.5 | B | A |
| | 21 | E-21 | 8.0 | P-1 | 4.0 | 2.0 | 8.5 | A | A |
| | 22 | E-22 | 8.0 | P-1 | 4.0 | 2.0 | 8.5 | A | A |
| | 23 | E-23 | 8.0 | P-1 | 4.0 | 2.0 | 8.5 | A | B |
| | 24 | E-24 | 8.0 | P-1 | 4.0 | 2.0 | 8.5 | B | A |
| | 25 | E-25 | 8.0 | P-1 | 4.0 | 2.0 | 8.5 | B | A |
| | 26 | E-26 | 8.0 | P-1 | 4.0 | 2.0 | 8.5 | A | A |
| | 27 | E-27 | 8.0 | P-1 | 4.0 | 2.0 | 8.5 | A | A |
| | 28 | E-28 | 8.0 | P-1 | 4.0 | 2.0 | 8.5 | A | B |
| | 29 | E-29 | 8.0 | P-1 | 4.0 | 2.0 | 8.5 | B | A |
| | 30 | E-30 | 8.0 | P-1 | 4.0 | 2.0 | 8.5 | A | A |
| | 31 | E-31 | 8.0 | P-1 | 4.0 | 2.0 | 8.5 | A | A |
| | 32 | E-32 | 8.0 | P-1 | 4.0 | 2.0 | 8.5 | A | B |
| | 33 | E-33 | 8.0 | P-1 | 4.0 | 2.0 | 8.5 | B | A |
| | 34 | E-34 | 8.0 | P-1 | 4.0 | 2.0 | 8.5 | A | B− |
| | 35 | E-35 | 8.0 | P-1 | 4.0 | 2.0 | 8.5 | B | A |
| | 36 | E-36 | 8.0 | P-1 | 4.0 | 2.0 | 8.5 | A | A |

TABLE 3-2
Evaluation conditions and evaluation results

| | | Resin particle | | | | | | | |
|---|---|---|---|---|---|---|---|---|---|
| | | dispersion liquid | | Pigment | | Ink | | | |
| | | | Content | dispersion liquid | | Mass ratio | | | |
| | | | of resin | | Content of | of resin | | Evaluation result | |
| | | | particles | | pigment | particles | pH | Storage | Image |
| | | Kind | (%) | Kind | (%) | to pigment | (—) | stability | clarity |
| Example | 37 | E-37 | 8.0 | P-1 | 4.0 | 2.0 | 8.5 | A | A |
| | 38 | E-38 | 8.0 | P-1 | 4.0 | 2.0 | 8.5 | A | B |
| | 39 | E-1 | 4.0 | P-1 | 4.0 | 1.0 | 8.5 | A | B |
| | 40 | E-1 | 5.0 | P-1 | 4.0 | 1.3 | 8.5 | A | A |
| | 41 | E-1 | 15.0 | P-1 | 4.0 | 3.8 | 8.5 | A | A |
| | 42 | E-1 | 16.0 | P-1 | 4.0 | 4.0 | 8.5 | A | A |
| | 43 | E-1 | 5.0 | P-1 | 6.3 | 0.8 | 8.5 | A | B |
| | 44 | E-1 | 5.0 | P-1 | 5.0 | 1.0 | 8.5 | A | A |
| | 45 | E-1 | 15.0 | P-1 | 3.0 | 5.0 | 8.5 | A | A |
| | 46 | E-1 | 15.0 | P-1 | 2.5 | 6.0 | 8.5 | A | A |
| | 47 | E-1 | 8.0 | P-1 | 4.0 | 2.0 | 6.8 | A | A |
| | 48 | E-1 | 8.0 | P-1 | 4.0 | 2.0 | 7 | A | A |
| | 49 | E-1 | 8.0 | P-1 | 4.0 | 2.0 | 9.5 | A | A |
| | 50 | E-1 | 8.0 | P-1 | 4.0 | 2.0 | 9.6 | A | B |
| | 51 | E-39 | 8.0 | P-1 | 4.0 | 2.0 | 8.5 | B | A |
| | 52 | E-40 | 8.0 | P-1 | 4.0 | 2.0 | 8.5 | A | A |
| | 53 | E-41 | 8.0 | P-1 | 4.0 | 2.0 | 8.5 | A | A |
| | 54 | E-42 | 8.0 | P-1 | 4.0 | 2.0 | 8.5 | A | A |
| | 55 | E-43 | 8.0 | P-1 | 4.0 | 2.0 | 8.5 | A | A |
| | 56 | E-44 | 8.0 | P-1 | 4.0 | 2.0 | 8.5 | A | B |
| | 57 | E-45 | 4.0 | P-1 | 5.0 | 0.8 | 6.8 | B | B |
| | 58 | E-1 | 8.0 | P-2 | 4.0 | 2.0 | 8.5 | A | AA |
| | 59 | E-1 | 8.0 | P-3 | 4.0 | 2.0 | 8.5 | A | AA |
| | 60 | E-1 | 8.0 | P-4 | 4.0 | 2.0 | 8.5 | A | AA |
| Comparative | 1 | E-46 | 8.0 | P-1 | 4.0 | 2.0 | 8.5 | B | C |
| Example | 2 | E-47 | 8.0 | P-1 | 4.0 | 2.0 | 8.5 | C | B |
| | 3 | E-48 | 8.0 | P-1 | 4.0 | 2.0 | 8.5 | B | C |
| | 4 | E-49 | 8.0 | P-1 | 4.0 | 2.0 | 8.5 | B | C |
| | 5 | E-50 | 8.0 | P-1 | 4.0 | 2.0 | 8.5 | C | B |
| | 6 | E-51 | 8.0 | P-1 | 4.0 | 2.0 | 8.5 | C | C |
| | 7 | E-52 | 8.0 | P-1 | 4.0 | 2.0 | 8.5 | C | A |
| | 8 | E-53 | 8.0 | P-1 | 4.0 | 2.0 | 8.5 | A | C |
| | 9 | E-54 | 8.0 | P-1 | 4.0 | 2.0 | 8.5 | A | C |
| | 10 | E-55 | 8.0 | P-1 | 4.0 | 2.0 | 8.5 | C | A |
| | 11 | E-56 | 8.0 | P-1 | 4.0 | 2.0 | 8.5 | C | C |
| | 12 | E-57 | 8.0 | P-1 | 4.0 | 2.0 | 8.5 | B | C |

According to the present disclosure, there can be provided the aqueous ink for ink jet, which can record an image having satisfactory image clarity and has satisfactory storage stability, and the ink cartridge and the ink jet recording method each using the aqueous ink. In addition, according to the present disclosure, there can be provided the aqueous resin particle dispersion liquid, which can prepare an aqueous ink for ink jet capable of recording an image having satisfactory image clarity and has satisfactory storage stability, and the method of producing an aqueous resin particle dispersion liquid.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-025597, filed Feb. 20, 2025, and Japanese Patent Application No. 2026-020931, filed Feb. 12, 2026, which are hereby incorporated by reference herein in their entirety.

What is claimed is:

1. An aqueous ink for ink jet comprising:
an aqueous medium; and
a resin particle,
wherein a resin for forming the resin particle is a copolymer having a unit derived from a monomer having an acid group,
wherein the resin particle contains 2 μmol/g or more to 60 μmol/g or less of an ammonium ion inside the resin particle, and
wherein a surface acid group amount (μmol/g) of the resin particle is 100 μmol/g or more to 400 μmol/g or less.

2. The aqueous ink according to claim 1, wherein the amount of the ammonium ion inside the resin particle is 5 μmol/g or more to 50 μmol/g or less.

3. The aqueous ink according to claim 1,
wherein the monomer having an acid group includes a monomer having a carboxylic acid group and a monomer having a sulfonic acid group, and
wherein a ratio (carboxylic acid group-to-sulfonic acid group molar ratio) of a molar amount of the carboxylic acid group to a molar amount of the sulfonic acid group is 10 or more to 20 or less.

4. The aqueous ink according to claim 1, wherein the resin particle has a glass transition temperature of 50° C. or more to 80° C. or less.

5. The aqueous ink according to claim 1, wherein 80% or more of surface acid groups of the resin particle are dissociated to have anionic properties at a pH of 9.

6. The aqueous ink according to claim 1,
wherein the surface acid group amount (μmol/g) of the resin particle is 250 μmol/g or more to 350 μmol/g or less, and
wherein 84% or more to 92% or less of surface acid groups of the resin particle are dissociated to have anionic properties at a pH of 9.

7. The aqueous ink according to claim 1, wherein the resin particle has a cumulative 50% particle diameter (D₅₀) of a volume-based particle size distribution of 50 nm or more to 200 nm or less.

8. The aqueous ink according to claim 1, wherein a content of the resin particle in the aqueous ink is 5.0% by mass or more to 15.0% by mass or less with respect to a total mass of the ink.

9. The aqueous ink according to claim 1, further comprising:
a pigment; and
a water-soluble organic solvent.

10. The aqueous ink according to claim 9, wherein a content (% by mass) of the resin particle in the aqueous ink is 1.0 times or more to 5.0 times or less in terms of mass ratio to a content (% by mass) of the pigment.

11. The aqueous ink according to claim 1, wherein a pH of the aqueous ink is 7.0 or more to 9.5 or less.

12. An ink cartridge comprising:
an ink; and
an ink storage portion configured to store the ink,
wherein the ink is the aqueous ink of claim 1.

13. An ink jet recording method comprising ejecting an ink from a recording head of an ink jet system to record an image on a recording medium,
wherein the ink is the aqueous ink of claim 1.

14. An aqueous resin particle dispersion liquid used for production of an aqueous ink for ink jet, the aqueous resin particle dispersion liquid comprising:
an aqueous medium; and
a resin particle,
wherein a resin for forming the resin particle is a copolymer having a unit derived from a monomer having an acid group,
wherein the resin particle contains 2 μmol/g or more to 60 μmol/g or less of an ammonium ion inside the resin particle, and
wherein a surface acid group amount (μmol/g) of the resin particle is 100 μmol/g or more to 400 μmol/g or less.

15. A method of producing an aqueous resin particle dispersion liquid for use in production of an aqueous ink for ink jet, the method comprising:
a first step of subjecting a monomer component including a monomer having an acid group to emulsion polymerization in the presence of an ammonium salt to provide a first aqueous dispersion containing a resin particle;
a second step of adjusting a pH of the first aqueous dispersion obtained in the first step to 6.5 or more to 9.5 or less to provide a second aqueous dispersion; and
a third step of performing heat treatment of the second aqueous dispersion at a temperature equal to or more than a glass transition temperature of the resin particle for 24 hours or less after the second step.
